(19) United States
(12) Patent Application Publication
(10) Pub. No.: US 2026/0304150 A1
(43) Pub. Date: Oct. 1, 2026

(54) BACKHAUL LINK CONTROL FOR SMART REPEATER

(71) Applicant: KONINKLIJKE PHILIPS N.V., EINDHOVEN (NL)

(72) Inventors: ROBERT JAMES DAVIES, Eindhoven (NL); OSCAR GARCIA MORCHON, Eindhoven (NL)

(21) Appl. No.: 19/100,694

(22) PCT Filed: Aug. 1, 2023
(86) PCT No.: PCT/EP2023/071219

§ 371 Date: Feb. 3, 2025

(30) Foreign Application Priority Data
Aug. 5, 2022 (EP) 22188966.0

(51) Int. Cl. H04W 24/02; H04W 24/10

(52) U.S. Cl. CPC H04W 24/02; H04W 24/10

(57) ABSTRACT

The invention proposes a wireless network comprising a primary station in communication with one or more terminal stations via a secondary station, said secondary station being configured to relay signals between the primary station and the one or more terminal station, the secondary station exchanging data with the primary station on a backhaul link and with the terminal station on an access link, wherein the network comprises an access link manager for managing access links between the secondary station and the terminal stations according to a measured quality derived from channel state information exchanged between the primary station and the terminal stations and a backhaul link estimator for estimating the quality of the backhaul link between the primary and secondary stations indirectly, and a backhaul link manager to adjust the backhaul link based on the indirect backhaul link estimation.

### FIELD OF THE INVENTION

The invention relates to the field of communication services for terminal devices including mobile access devices in wireless networks, such as—but not limited to—smart repeaters or reflective intelligent surfaces used in terrestrial networks or satellites used in non-terrestrial networks.

### BACKGROUND OF THE INVENTION

RF repeaters have been a feature of cellular networks for some years, where their ability to economically patch holes in the coverage of a cell has earnt them a useful role. Prior to release 18, a cellular repeater compromised two back-to-back amplifying repeater chains, each themselves comprising an input stage, some means of filtering out out-of-band signals and an amplifier. When the inputs and outputs are connected to appropriate antenna systems, one covering the so-called access channel between repeater and terminal and the other the so-called backhaul between access device and repeater, a repeater offers a transparent, on-channel repeater service to a terminal device (e.g., User Equipment (UE)) that might be out of direct coverage of the access device (e.g., base station or access point).

A particular advantage of this approach is that no changes are required to the protocol between access device and terminal device, meaning that the repeater is entirely compatible with the cellular system.

In recent standards work, attention is being paid to improving the performance of a repeater by allowing aspects of its behaviour to be controlled by the access device. One problem with repeaters prior to release 18 is that they are always ‘on’—that is, the amplifiers are always operational. This is true even when there is no signal to repeat. In this case, the amplifier simply relays any noise and interference at its input to the output. This means that areas served by repeaters can suffer from a higher level of background noise and interference. Conversely, noise picked up at the input to the uplink side of the repeater is transmitted towards the access device.

Thus, consideration is now being given to allowing the access device to control when the repeater's amplifiers are switched on and what level of amplifier gain should be used. Since, in cellular and some wireless networks, the access device has overall responsibility for scheduling the usage of the frequency range over which it operates, the access device has the knowledge necessary for both uplink and downlink to determine when the repeater amplifiers should be switched on. By arranging for a local controller in the repeater, connected to the access device via a control channel, to operate the repeater as required by the access device, improved operation can be achieved.

Such a repeater is referred to as a networked-controlled repeater (NCR), to differentiate it from the legacy, non-controlled repeaters. In this description, the term, ‘smart repeater’ is assumed to be the same as NCR.

Advantageously, the local controller, known as the NCR-MT, operates according to at least a subset of the cellular protocol used between access devices and terminal device and may be handled, at least on the control side as a standard terminal device. One difference between the backhaul and the control channels, in this respect, is that the control channel is terminated at the NCR-MT and signals sent to the NCR-MT are not forwarded to the access channel.

For 5G, it is envisaged that repeaters will be of particular value in the 5G FR2 frequency range, which covers so-called mmWave frequencies (24250 MHz-52600 MHz) (TS 38.101-1). The shorter range of mmWave frequencies compared to their FR1 counterparts (410-7125 MHz) means that achieving uniform coverage of a given area will be more challenging for frequency bands in the FR2 range and repeaters could be a valuable tool in network planning. The same may also be true in other networks, where there is a tendency to use higher frequencies to obtain improved bandwidth and latency. MIMO techniques like beam forming are already in use at lower frequencies for improved coverage and reliability. Use of mmWave frequencies offer much increased scope for MIMO and future systems are expected to take full advantage. Thus, in order to optimize the RF paths between access device and repeater, and between repeater and terminal device, we can expect smart repeaters to have beam-forming capabilities both on the so-called access side (between repeater and terminal device) and on the so-called backhaul side (between access device and repeater). Both sets of beams would need to be controlled by the access device.

Normally, information used to configure beam forming operation and other signalling aspects is obtained through the exchange of channel sounding signals, sometimes collectively known as channel state information (CSI) signals, between an access device and a terminal device with the sender using feedback reported by the receiver to provide closed-loop control of the beam. For the NCR, a similar process is used to manage the control link between the access device and the NCR-MT.

For the terminal devices, the repeater introduces an extra link—the backhaul—which is not explicitly accounted for by the CSI mechanism. Because there is no entity within the repeater that can perform the necessary lower layer UE functions for CSI reporting across the backhaul and no mechanism for uplink beam steering, this means that the CSI information exchanged between the access device and a terminal device actually reports on the series combination of backhaul and access link. In the event of a report of poor channel quality, which link needs to be adjusted?

An alternative to using amplifiers for the repeater functionality is to use a switchable metasurface. Switchable metasurfaces have been recently developed and offer many possibilities for improving a wireless communication path between an access device of a wireless network and a terminal device.

A variety of technologies can be employed to implement such switchable metasurfaces. Generally, electronically switched metasurfaces are employed, but physically moveable reflecting patches are also a viable technology. In general, as long as the general set of desired properties are implemented, there is no reason that these surfaces cannot be constructed by using any relevant technology. Metasurfaces can even be used to form independent communications infrastructures using backscattered ambient radio signals.

Metasurfaces may be composed of periodic subwavelength metal/dielectric antennae that resonantly couple to the electric or magnetic or both components of the incident electromagnetic fields, exhibiting effective electric (represented by electric permittivity ε) and/or magnetic (represented by magnetic permeability μ) responses not found in nature.

Thus, metasurfaces represent a versatile concept for the manipulation of electromagnetic waves. Due to the ease of fabrication using planar circuit manufacturing, there is significant application potential for the microwave frequency range. Huygens metasurfaces have received significant attention as they feature near unity transmission and suppress reflection artifacts efficiently. For microwave frequencies, Huygens metasurfaces are usually manufactured in printed circuit board (PCB) processes with three structured copper layers separated by low-loss dielectric substrates.

Metamaterials will be useful in many aspects of e.g. 5G wireless communication solutions. Syed S. Bukhari et al.: “A Metasurfaces Review: Definitions and Applications” provides a review of metasurfaces. Purely passive metasurfaces are useful, but only act as permanent changes to the transmission environment.

A reconfigurable metasurface for mm-wave networks (“mmWall”) has been proposed by Kun Woo Cho et al.: “mmWall: A Reconfigurable Metamaterial Surface for mmWave Networks”, which is a tunable smart surface made of metamaterial which, unlike a conventional wireless relay system, does not have transmitting and receiving antennas, nor an amplifier. Once the incoming beam hits the metasurface, it naturally refracts the beam into a desired direction, regardless of whether the transmitter and receiver are located in the same room (“mirror” mode) or in a different room (“lens” mode). Also, it can split the incoming signal into multiple beams and concurrently steer the multi-armed beams. The authors used “Huygen's metasurfaces” to implement their design.

There are however other technologies for switchable mm-wave manipulating surfaces apart from metasurfaces.

Furthermore, Large Intelligent Surfaces (LIS) and a model for integration of base stations and LIS to determine the benefits of different proportions of each in a communications network has been disclosed in Yongxu Zhu et al.: “Stochastic Geometry Analysis of Large Intelligent Surface-Assisted Millimeter Wave Networks”. They concluded that, where there are a limited number of base stations, the contribution of LIS is good, but this is not the case where there are very many base stations serving users.

Moreover, in Jun Zhao et al.: “A Survey of Intelligent Reflecting Surfaces (IRSs): Towards 6G Wireless Communication Networks”, the authors term the surfaces “Intelligent Reflecting Surfaces” and the behavior is limited to reflection rather than both reflection and transmission.

With a metasurface, there are still two parts to a link between an access device and a terminal device and still only one set of channel quality information effectively covering both links in series. Thus, again, in the event of poor channel quality, it needs to be determined which part of the link needs to be adjusted.

### SUMMARY OF THE INVENTION

It is an object of the present invention to improve the handling of poor link quality experienced by an access device and a terminal device when the link passes through a reconfigurable relay device (RRD), such as a smart repeater or an externally controlled RIS which lack intrinsic capacity to perform their own radio sensing (“fully passive RIS”), and partially active RISs which may include e.g. some radio capabilities, signal processing capabilities, sensors, motors to change orientation of individual sub-panels/sub-elements of the RIS, or active elements to not only modify the angle/polarization of the reflected electromagnetic wave, but also to amplify it etc.

This object is achieved by a secondary station, a method a network as defined in the attached set of claims and that can be implemented by a computer program product.

In accordance with a first definition of the invention, it is proposed in a first aspect, a method for operating a network, said network comprising a primary station in communication with a terminal station via a secondary station, said secondary station being configured to relay signals exchanged between the primary station and the terminal station, the secondary station exchanging data with the primary station on a backhaul link and with the terminal station on a dedicated access link,

the method comprising managing the access link according to a measured quality between the primary station and the terminal station or to an indirect estimation of channel quality and,

managing the quality of the backhaul link based on an indirect estimation or according to a measured quality.

Similarly, it is proposed in a second aspect of the invention a method for operating a primary station in a network, the primary station being in communication with one or more terminal station via a secondary station, said secondary station being configured to relay signals exchanged between the primary station and the one or more terminal station, the secondary station exchanging data with the primary station on a backhaul link and with the terminal station on a dedicated access link,

the method comprising the primary station managing the access according to a measured quality between the primary station and the terminal station and,

the primary station managing the quality of the backhaul link between the primary station and the secondary station based on an indirect estimation or according to a measured quality.

In accordance with a third aspect of the invention, it is proposed a method for operating a secondary station in a network, said network comprising a primary station in communication with one or more terminal station via the secondary station, said secondary station being configured to relay signals exchanged between the primary station and the terminal station, the secondary station exchanging data with the primary station on a backhaul link and with the terminal station on a dedicated access link,

the method comprising the secondary station monitoring probe signals from the primary station for the terminal stations and/or from the terminal stations to the primary station,

generating a backhaul link quality report to be sent to the primary station.

Further, in accordance with a fourth aspect of the current definition of the invention, it is proposed a secondary station operating in a network, said network comprising a primary station in communication with a terminal station via the secondary station, said secondary station being configured to relay signals exchanged between the primary station and the one or more terminal stations, the secondary station exchanging data with the primary station on a backhaul link and with the terminal station on a dedicated access link,

the secondary station comprising a controller for monitoring channel state information signals from the primary station for the terminal stations, the controller being arranged to control a transmitter to transmit a backhaul link quality report to be sent to the primary station.

Additionally, in accordance with a fifth aspect of the current definition of the invention, it is proposed a method for operating a secondary station in a network, said network comprising a primary station in communication with a terminal station via a secondary station, said secondary station being configured to relay signals exchanged between the primary station and the terminal station, the secondary station exchanging data with the primary station on a backhaul link and with the terminal station on a dedicated access link,

the method comprising sending a probe signal to the primary station, so that an estimation of the backhaul link quality is done at the primary station.

In accordance with a sixth aspect of the definition of the invention it is proposed a secondary station operating in a network, said network comprising a primary station in communication with a terminal station via the secondary station, the secondary station being configured to relay signals exchanged between the primary station and the terminal station, the secondary station exchanging data with the primary station on a backhaul link and with the terminal station on an access link,

the secondary station comprising a transmitter for sending a probe signal to the primary station, so that an estimation of the backhaul link quality is done at the primary station.

In accordance with a seventh aspect of the current definition of the invention, it is proposed a primary station operating in a network, said primary station being in communication with a terminal station via a secondary station, the secondary station being configured to relay signals exchanged between the primary station and the terminal station, the secondary station exchanging data with the primary station on a backhaul link and with the terminal station on an access link,

the primary station being configured to receive a probe signal from the secondary station, and to estimate a backhaul link quality based on measurements on the probe signal,

the primary station being configured to adjust the backhaul link on the basis of the backhaul link quality.

In accordance with an eighth aspect of the current definition of the invention it is proposed a wireless network comprising a primary station in communication with a terminal station via a secondary station, said secondary station being configured to relay signals between the primary station and the one or more terminal station, the secondary station exchanging data with the primary station on a backhaul link and with the terminal station on an access link,

wherein the network comprises

an access link manager for managing access links between the secondary station and the terminal stations according to a measured quality between the primary station and the terminal station or to an indirect estimation of channel quality and

a backhaul link estimator for estimating the quality of the backhaul link between the primary and secondary stations indirectly, and

a backhaul link manager to adjust the backhaul link based on the indirect backhaul link estimation or according to a measured quality.

According to a first aspect related to an access device (e.g. base station (gNB) or access point), an apparatus is provided for controlling a communication path in a wireless network, the apparatus comprising:

a registration controller for discovering and/or registering a reconfigurable relay device in the wireless network;

a path establisher for determining and establishing a wireless communication path to at least one target terminal device via at least one registered reconfigurable relay device; and

a state controller for controlling a redirection pattern of the at least one reconfigurable relay device in accordance with the established wireless communication path; determining independent link quality estimates for the backhaul link between the access device and the at least one reconfigurable relay device, and the access link between the at least one reconfigurable relay device and the at least one terminal device; and using the link quality estimates to independently optimise the quality of the access link and the backhaul link.

According to a second aspect related to the access device (e.g. base station (gNB) or access point), a method is provided for controlling a communication path in a wireless network, the method comprising:

discovering and/or registering a reconfigurable relay device in the wireless network;

determining and establishing a wireless communication path to at least one target terminal device via at least one registered reconfigurable relay device; and

controlling a redirection pattern of the at least one reconfigurable relay device in accordance with the established wireless communication path.

determining independent link quality estimates for the backhaul link between the access device and the reconfigurable relay device, and the access link between the reconfigurable relay device and the at least one terminal device, and using the link quality estimates to independently optimise the quality of the access link and the backhaul link.

According to a third aspect, a reconfigurable relay device (e.g. an RIS or a smart repeater) is provided, which is configured to control a redirection pattern for relaying at least one received wireless signal in response to a relay state command received from a remote controller device of a wireless network to establish a wireless communication path to a target terminal device, wherein the reconfigurable relay device can be set to one of a plurality of configuration states in response to the relay state command, wherein each of the configuration states results in one of a plurality of redirection patterns of the received wireless signal, and wherein the plurality of redirection patterns comprise at least one of a reflection with a given reflection angle, a focusing or defocusing, a generation of multiple beams, a refraction with a given refraction angle, and an absorption and wherein each of the plurality of redirection patterns comprises a backhaul link between the access device and the reconfigurable relay device, and an access link between the reconfigurable relay device and the at least one terminal device.

According to a fourth aspect, an access device is provided, which comprises the apparatus of the first aspect.

According to a fifth aspect, a system is provided, which comprises at least one access device of the fourth aspect, at least one reconfigurable relay device of the third aspect, and a relay installation database for storing information about installed reconfigurable relay devices.

Finally, according to a sixth aspect, a computer program product is provided, which comprises code means for producing the steps of the method of the second aspect when run on a computer device.

The proposed path establishment via at least one reconfigurable relay device offers significant benefits for radio communication systems, particularly those using high frequencies such as 5G mm-wave. This is because such frequencies are readily absorbed by many materials and thus blind spots are more common with these systems.

A scenario for installation of a reconfigurable relay device (RRD) is that an owner of a building wants to improve reception quality of wireless communications, e.g., 5G based, within the building. The occupants of the building might be his/her own staff, an Industrial Internet of Things (IIoT) network or possibly the general public (e.g., in a public building). More likely, the owner might wish to improve reception on all wireless communication networks supplying individuals in the building. Therefore, it may be desirable that the RRDs are used by all networks to improve communications with the people inside the building. Therefore, the owners of the devices would wish to enable them to be integrated with the operations of the wireless communication, e.g., 5G based, network operators.

Another scenario for a reconfigurable relay device is the operator of a vehicle wanting to provide improved reception for passengers. A vehicle in this scenario can be a private automobile or a multi-passenger vehicle such as a bus, coach or train. In each case, the objective is to provide the passenger with network access unhindered by the vehicle's structure.

A priority ordering of networks might be determined, for example by the statistics of the networks supplying users within that building. Moreover, several networks might be given paid access to the RRDs, possibly setting priorities on use of the RRDs according to an auction or fixed fee charged for 1st place, 2nd place etc within the controller priority list.

Systems with reconfigurable relay devices such as RISs or smart repeaters are likely to be significantly cheaper than additional base stations. The proposed reconfigurable relay devices may be “passive” in the sense that they are controlled by an external controller, most likely a core network device or an access device (e.g., base station) performing the search for communication paths. It is possible to integrate some form of radio sensing and internal control into these systems, whereby the reconfigurable relay device becomes responsible for setting its state based on e.g. beam search to the target terminal device.

Specifically, the following advantages can be achieved:
Installed reconfigurable relay devices or systems can be setup to be controlled by one or more networks in a way which enables their valid and secure operation in communication systems, and which handles edge cases such as non-operation of a reconfigurable relay system.
The operation of multiple networks seeking to use a single reconfigurable relay device at the same time in setting up communication paths can be handled.
Means can be provided for rapid calculation of a radio frequency (RF) communication signal path via such a reconfigurable relay device from an access device to a terminal device.
Additional independent communication paths can be established, for example two UEs located in the same direction from the access device can be served on the same frequency by beam forming directly towards one and beam forming via a reconfigurable relay device to the other, or for two access devices beaming towards two UEs respectively, for one to use a path via the reconfigurable relay device (even though there is a direct line of sight (LoS) to that UE) to again avoid interference if that LoS path would impact the other UE and the relay-directed path would not.

Accordingly, newly installed reconfigurable relay systems can be registered such that the network or access device has an ability to command them to desired states, including discovery methods if a formal registration process for the reconfigurable relay device is not available. This allows discovery, set up and ongoing operation of the control of a fully passive reconfigurable relay device by the network or its access devices. Moreover, competition over control of purely passive reconfigurable relay device between different networks and/or network operators is allowed. Even when a reconfigurable relay device is formally registered (by itself or by its owner) in a database, the access device may still need to discover or try out that reconfigurable relay device if it is reachable from the access device and whether it can help to establish useful communication paths to terminal devices.

Additionally, the proposed solution provides an optimum approach to finding a communication path to a UE via a reconfigurable relay device, given that the access device (e.g., base station) provides a potentially large number of beam formed directions, only a few of which interact with the reconfigurable relay device, and that there may be a very large number of states for the reconfigurable relay device, most of which result in no communication path to the terminal device or there may be very many individual elements in a reconfigurable relay device so that checking through each element is not feasible and taking into account that any communication path to the terminal device comprises both a backhaul and an access link that are, in general independent of each other.

Furthermore, queries and commands to the reconfigurable relay systems can be formatted and sent to support their use in communication with end users where the command/query communication meets security and acceptability requirements (e.g., the network has appropriate priority and authorization for use of a reconfigurable relay device if required).

Moreover, the proposed system can be applied in outdoor and indoor environments as well. A likely scenario may be the improvement of connectivity outdoors, e.g., in city scenarios where due to buildings, cars, etc. the reception quality might not be as good as desirable. In this scenario, RISs installed in the city environment, e.g., in building facades, billboards, etc. are used by network operators to improve network connectivity and services.

Moreover, the proposed system can be applied to scenarios where the RRD is mobile and may be travelling with a number of terminal devices. The RRD may provide the terminal devices with a reliable link via the access channel and may connect them to the network via the backhaul channel. In this scenario, conditions of poor reception quality may be due to the backhaul channel rather than the access channel.

According to a first option which may be combined with any of the above first to sixth aspects, the reconfigurable relay device may be looked up (e.g. by the registration controller) in a relay installation database and a required registration method may be queried from the relay installation database or the reconfigurable relay device, or the reconfigurable relay device may be discovered by using autodiscovery in a locality method where local transmission paths with variable properties are noted. Thereby, path establishment can be adapted to new network configurations to ensure optimal communication paths.

According to a second option which may be combined with the first option or any of the above first to sixth aspects, the path establishment may be configured to apply a transmission modelling within a local radio transmission model of a local environment to search for suitable beam paths, or to use results of previous beam directions plus relay states and UE locations stored in a database, or to use an artificial intelligence model for learning a relation or association between beam settings and parameters, relay states of nearby reconfigurable relay devices and/or UE location(s) as input parameters and link quality and/or performance to the target terminal device as output parameters. Thus, communication paths which include relevant reconfigurable relay systems can be planned, avoiding exhaustive real-world search through beam directions of access devices and relay states.

According to a third option which can be combined with the first or second option or any of the above first to sixth aspects, the redirection pattern applied to at least one beam on the wireless communication path may be controlled by using a scheduling request. Thereby, scheduling considerations for future configuration states of the reconfigurable relay device can be added to the control actions.

According to a fourth option which can be combined with any of the first to third options or any of the above first to sixth aspects, a timing advance can be applied in path establishment to compensate for a longer transmission path length via the reconfigurable relay device. This measure ensures that reception times at the target terminal device can be properly controlled.

According to a fifth option which can be combined with any of the first to fourth options or any of the above first to sixth aspects, the reconfigurable relay device may be queried to determine a current configuration state. Thereby, current redirection patterns of the reconfigurable relay device can be considered in the path planning and establishment process.

According to a sixth option which can be combined with any of the first to fifth options or any of the above first to sixth aspects, the reconfigurable relay device may be a reconfigurable intelligent surface or other switchable metamaterial surface or a smart repeater. Thus, switchable metamaterial surfaces and/or reconfigurable intelligent surfaces can be combined with smart repeaters or they can be selected for achieving an optimized network environment.

According to a seventh option which can be combined with any of the first to sixth options or any of the above first to sixth aspects, the reconfigurable relay device may comprise metadata including at least one of information required for deriving capabilities of the reconfigurable relay device and its control by a network, location and/or orientation information, a set of configuration states, a default configuration state, a reconfiguration speed, authentication, control and query methods, and a network control prioritization procedure. This option increases efficiency of path planning and establishment by providing a variety of initial information.

According to an eighth option which can be combined with any of the first to seventh options or any of the above first to sixth aspects, the reconfigurable relay device may comprise current information data including at least one of a current relay state indicating a currently set configuration state, a current controller priority parameter (e.g. priority number) which is set to a priority of a current controller, a first flag indicating if the current relay state is being currently commanded, a timer value indicating for how long the current relay state has been commanded, and a second flag indicating an out of operation state. This option increases efficiency of path planning and establishment by providing enhanced information about the current state of the reconfigurable relay device. For example, it can be determined whether a registered reconfigurable relay device is no longer functional, so that it can be removed from the possible communication paths with end user UEs.

According to a ninth option which can be combined with any of the first to eighth options or any of the above first to sixth aspects, the reconfigurable relay device may comprise at least one sensor for obtaining a location and/or orientation of the reconfigurable relay device. Thereby, the reconfigurable relay device can obtain direct information about its location and/or orientation, which may be signaled to a database, or (directly/indirectly) to a controlling access device that can use it for path planning.

According to a tenth option which can be combined with any of the first to ninth options or any of the above first to sixth aspects, the reconfigurable relay device may comprise a network usage log which stores information about usage times of the relay device. This log information can be used to derive usage information for evaluating efficiency and/or proper placing of the reconfigurable relay device.

According to an eleventh option which can be combined with any of the first to tenth options or any of the above first to sixth aspects, the reconfigurable relay device may comprise a priority list for storing priorities of networks or devices that control the reconfigurable relay device, wherein the reconfigurable relay device is configured to compare a new priority of a new remote controller or a new controlling network with a current priority of a current remote controller or a currently controlling network and if the new priority is higher, the reconfigurable relay device ceases the control by the current remote controller or the current network and allows control by the new remote controller or new network. This provides the advantage that priority considerations can be included in path planning and scheduling based on urgency or importance of a communication path. Moreover, a network prioritization scheme can be used to prevent deadlock in the control of a reconfigurable relay device by multiple competing users.

According to a twelfth option which can be combined with any of the first to eleventh options or any of the above first to sixth aspects, the reconfigurable relay device may comprise a scheduler for scheduling configuration states requested by one or more networks or devices and for determining whether a requested configuration state can be accepted or not. Thereby, multiple networks and/or access devices can use the reconfigurable relay device in parallel and total transmission time can be reduced by scheduling same configuration states at same time periods. Additionally, transmissions can be planned in advance (e.g., recurring transmissions), or e.g. in cases where new data for transmission is expected shortly, a pre-scheduled time slot for use of the RIS can be faster than trying to negotiate a RIS at the time of the next transmission.

According to a thirteenth option which can be combined with any of the first to twelfth options or any of the above first to sixth aspects, the reconfigurable relay device may comprise apparatus for making observations of the quality of signals passing through or across it, wherein a quality report may be prepared and delivered to the access device.

It is noted that the above apparatus may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the method of claim 1, 2, 16, 21, the secondary station of claims 20, 28, the primary station of claim 29, the wireless network of claim 31 may have similar and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 schematically shows a summarizing architecture of an RIS registration and control system according to various embodiments;

FIG. 2 schematically shows a flow diagram of an RIS registration and control method according to various embodiments;

FIG. 3 schematically shows an RIS discovery and registration process according to an embodiment with RIS installation database;

FIG. 4 schematically shows an RIS discovery and registration process according to an embodiment with RIS request for registration;

FIG. 5 schematically shows an RIS discovery and registration process according to an embodiment with autodiscovery;

FIG. 6 schematically shows an RIS query and command process according to an embodiment;

FIG. 7 schematically shows a network control prioritization process according to an embodiment;

FIG. 8 schematically shows a communication path establishment process according to an embodiment with exhaustive search;

FIG. 9 schematically shows a communication path establishment process according to an embodiment with beam path memory;

FIG. 10 schematically shows a failure recognition process according to an embodiment;

FIG. 11 schematically shows a flow diagram of a process for an RIS enabled communication according to various embodiments;

FIG. 12 schematically shows a first example of an improved beam steering process according to an embodiment; and

FIG. 13 schematically shows a second example of an improved beam steering process according to an embodiment.

FIG. 14 schematically shows an example of the management of beam steering process and CSI estimation according to an embodiment.

### DETAILED DESCRIPTION OF EMBODIMENTS

Embodiments of the present invention are now described based on a 5G cellular network environment.

Throughout the present disclosure, the abbreviation “gNB” (5G terminology) or “BS” (base station) is intended to mean access device such as a cellular base station or a WiFi access point. The gNB may consist of a centralized control plane unit (gNB-CU-CP), multiple centralized user plane units (gNB-CU-Ups) and/or multiple distributed units (gNB-Dus). The gNB is part of a radio access network (RAN), which provides an interface to functions in the core network (CN). The RAN is part of a wireless communication network. It implements a radio access technology (RAT). Conceptually, it resides between a communication device such as a mobile phone, a computer, or any remotely controlled machine and provides connection with its CN. The CN is the communication network's core part, which offers numerous services to customers who are interconnected via the RAN. More specifically, it directs communication streams over the communication network and possibly other networks.

Furthermore, the terms “base station” (BS) and “network” are often used as synonyms in this disclosure. This means for example that when it is written that the “network” performs a certain operation it may be performed by a CN function of a cellular network, or by a specific base station that is part of such cellular network, and vice versa. It can also mean that part of the functionality is performed by the cellular network and part of the functionality by the base station.

Additionally, the term “validation” is intended to refer to a process or act that may include typical information technology (IT) security operations such as decryption, signature checking, authentication, authorization etc.

A Network-Controlled Repeater (NCR), for which the term “smart repeater” is used as a synonym in this disclosure, comprises at least a first pair of RF amplifiers, one operating in the uplink direction (terminal device to network), the other in the downlink direction (network to terminal device) that operate under the local control of an NCR-MT (NCR Mobile Termination) that is linked to the network via a control link. This provides the network with the ability to control the behaviour of the RF amplifiers, for example, whether they are switched off or on, the operating gain and so on. In general, the network will control the amplifiers so that signals sent across the backhaul link from the network are relayed transparently across the access link to the terminal devices and vice versa.

The NCR also comprises an antenna system on the access link, used for transmission and reception to and from the terminal devices, another antenna system on the backhaul link, used for transmission and reception to and from the network and a third antenna system on the control link, used for transmission and reception between the NCR-MT and the network. The antenna systems on the backhaul and control links may be shared but, in general, are independent systems that may operate on different frequency bands. All antenna systems may possess some directional capability, which is, again intended to be under the control of the network. In this respect, the control link may behave in a similar manner to that between the network and a directly-connected UE. The access link may behave as an extension of the network's own directional antenna capabilities transported to the location of the NCR. In both cases, information for the appropriate control of the antenna radiation direction may be obtained from channel state information (CSI) signals exchanged between the network and the NCR-MT or the network and each terminal device.

For the backhaul link there is no equivalent to CSI signalling because the NCR operates transparently to signals on the backhaul and access paths. That means that there is no direct method of measuring the quality of the backhaul link and no easy way to determine the most appropriate settings. Since it operates in series with the access links, a problem with the backhaul link potentially affects all terminal devices using the NCR. In some cases, where the backhaul and control links can share resources, the backhaul link can default to the settings used by the control link. In other cases where this is not possible, other methods need to be used. It is an aim of the present disclosure to describe such methods.

A wide range of names have been given to (large area) surfaces which can passively alter the direction of radio waves impacting on them, but these reflection or transmission properties can be changed and/or switched and/or reconfigured to result in different passive behavior according a “state” they have been set to. These names include intelligent reflective surface (IRS), reconfigurable intelligent surface (RIS), large intelligent surface (LIS), reconfigurable metasurface (RM), programmable metasurface (PM), large intelligent metasurface (LIM), smart reflect-arrays (SRA), software-defined metasurface (SDM), software-defined surface (SDS), passive intelligent surface (PIS), and passive intelligent mirror (PIM).

These surfaces may be switchable between different states, where each state reflects or transmits the radio waves in a different way. A difference existing within these types of surfaces is that some have an intrinsic ability to determine signal strengths, for example they include an ability of a receiver as well as a reflector/transmitter, and therefore can act as an independent “relay-like” system, for example performing their own beam path search (albeit with reflected/transmitted signals originating elsewhere). Their similarity to relays enables them to be integrated into communication standards, e.g., cellular standards, as such.

Such switchable metamaterial surfaces offer many possibilities for improving the communication path between a base station or other type of access device and a terminal device (e.g., UE).

In the following, the term “reconfigurable intelligent surface” or “RIS” will be used to refer to any of the above surface types. In embodiments, it may be assumed that arrays of RISs are fully passive, that is, they have no intrinsic radio sensing capabilities and therefore cannot themselves perform beam search or similar but can be defined by switching states when commanded to by an external controller and it is the responsibility of the external controller to determine the appropriate state to set the RIS to. A RIS may also be partially passive and/or partially active (e.g. include some radio capabilities, signal processing capabilities, sensors, motors to change orientation of individual sub-panels/sub-elements of the RIS). It is noted that throughout the present disclosure only those blocks, components and/or devices that are relevant for the proposed data distribution function are shown in the accompanying drawings. Other blocks have been omitted for reasons of brevity. Furthermore, blocks designated by same reference numbers are intended to have the same or at least a similar function, so that their function is not described again later.

In many cases, a RIS can be used where a smart repeater/NCR might be used and vice versa. For both RIS and smart repeater/NCR, the problem of control of the backhaul link is similar. In the following, the terms RIS and smart repeater/NCR can be used interchangeably (unless it is specifically indicated to only apply to smart repeater/NCR or RIS). The term “reconfigurable relay device (RRD)” is used to denote RIS and/or smart repeater/NCR or any other device enabling the same functionality.

The following embodiments allow for enhanced link quality control for a wireless communication involving an access device (e.g., base station (BS)), RRD and terminal device (e.g., UE).

More specifically, RRDs may be seamlessly integrated into a 5G network via maintenance by a BS (e.g., gNB in 5G terminology) of a 3D transmission database of the local area, which may include buildings, objects, neighboring BSs, and which may include all known RISs and their properties (including operations of RRDs and means of controlling them). A resulting 3D radio propagation model may be used, along with some limited local search, for selection of communication channels including both the BS beam direction(s) and the states of the RRDs controlled by the network and/or BS.

During usage, the BS performs an analysis of the communication required, which may depend on the estimated locations of (the UEs of) users, and the predictions from its 3D radio propagation model (e.g. based on the above mentioned 3D transmission database). The BS may use its beam forming capabilities and may actively switch/control the behavior of the RRDs under its control to maximize communications quality and/or throughput, preferably whilst minimizing the transmission power levels.

The following descriptions use the RIS as a representative example of an RRD. It should be understood that a smart repeater/NCR can be used in place of a RIS (unless it is specifically indicated to only apply to smart repeater/NCR or RIS) and, therefore, the descriptions also cover operation with an smart repeater/NCR.

### RIS CONTROL INTERFACE AND ARCHITECTURE

The following embodiments cover a registration process, a RIS query and command process, a communication path establishment method from the BS, via the RIS to the UE, a network control prioritization process on command originators (i.e. controllers), and an RIS failure recognition process.

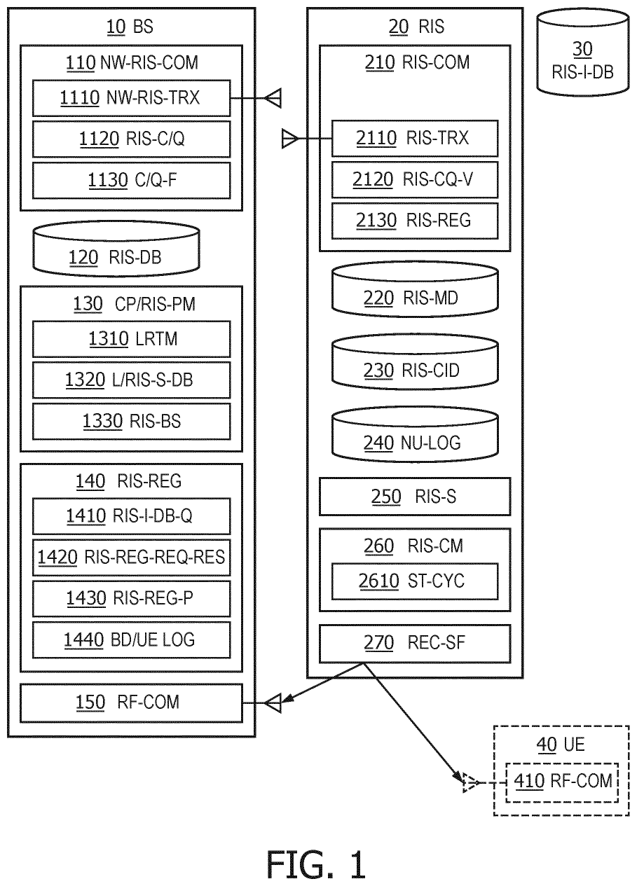

FIG. 1 schematically shows a summarizing architecture (with optional elements and functions) of an RIS registration and control system according to various embodiments.

The proposed system for a RIS enabled communication comprises base stations (BS) 10, at least one reconfigurable relay device, e.g. a Reconfigurable Intelligent Surface (RIS) 20 and terminal devices (UE) 40 of user.

The RIS-controlling base station 10 comprises an RF communication capability (RF-COM) 150 according to the involved communication standard (e.g., 5G NR) and a network to RIS communication system (NW-RIS-COM) 110, also known as state controller, as a means of sending and receiving communications to/from the RIS 20, which may simply be communications to the RIS 20 using its standard communication facilities, e.g., based on the F1-C interface, or may include messages sent to a specified Internet address. It includes a BS to RIS transmission and reception system (NW-RIS-TRX) 1110, an RIS query and command capability (RIS-C/Q) 1120, and a command/query formatting for validation procedure (C/Q-F) 1130.

The UE 40 comprises an RF communication capability (RF-COM) 410 for enabling communication with the BS 10 according to the involved communication standard (e.g., 5G NR).

Furthermore, the BS 10 comprises an optional RIS database (RIS-DB) 120 containing a list of local RISs and their metadata and optionally the BS beam direction to target each RIS. It might just store beam directions to target each specific RIS. Optionally, the metadata sourced from the RIS 20 may be extended to include aspects of its performance as determined by the network or BS 10, such as its optimal beam direction, availability, utility in communication, changes in performance according to weather and time of year etc.

The RIS database 120 may be divided into RIS information which is general to a network controlling many local BSs (e.g. the location of a RIS or the capabilities of a RIS) and information which is specific to individual BSs (e.g. whether a specific UE can be reached via a RIS controlled by that BS). For example, access to a specific RIS may be negotiated for a network operator by any of its BSs and certain information may be generic for that RIS to all BSs. However, the ability to use a specific RIS may differ between the individual BSs, for example an RIS may become obscured for one BS but not for another.

Additionally, the BS 10 comprises a communication path including RIS planning module (CP/RIS-PM) 130 which may include:
An optional local radio transmission model (LRTM) 1310 of its local environment, including the presence, location and behavior of any RISs which can be used to identify a correct configuration of a BS beam direction, selection of RIS and RIS state to communicate with a UE at a defined location. Optionally, the performance of the RIS in the local radio transmission model 1310 may be determined based on the calculated additional RIS database components, such as performance according to weather and time of year.
An optional database (L/RIS-S-DB) 1320 for storing UE location, RIS metadata (e.g. RIS capabilities, RIS location and/or RIS state), and linking a specific RIS, a state setting of that RIS and the location(s) of UEs which were successfully communicated with by the BS 10 using that RIS and RIS state, given one or more UE locations, the identity and location of the RIS (alternatively a beam direction to that RIS), and/or the RIS state associated with past communication via the RIS to that UE location.
An optional RIS beam search capability (RIS-BS) 1330 which may provide for local or global search through the states of an RIS for optimal communication with a UE (whereby the local states may be derived or retrieved from an RIS state topological map included in RIS metadata).

Moreover, the BS 10 comprises an RIS registration capability (RIS-REG) 140, also known as registration controller, including at least one of:
An optional RIS installation database querying (RIS-I-DB-Q) function 1410 that provides the ability to query an RIS installation database (RIS-I-DB) 30 to determine new entries in the RIS installation database 30 useable by the RIS controlling network or BS 10 to return means required for negotiating access to an RIS.
An optional RIS registration request response (RIS-REG-REQ-RES) function 1420 that provides the ability to respond to a communication from an RIS to set up the registration entry as part of the RIS registration process. This may as well be hosted in a network, e.g. the Internet, or a specific operator network in case the RIS is associated to a particular operator.
An RIS registration process capability (RIS-REG-P) 1430 that provides the ability to negotiate access to a RIS including at least one of negotiating a means of validation, getting control and query access, agreeing a price and pricing method (if any) and a means of getting access to the RIS metadata 220 and/or entering it into the RIS database 120.
An optional beam direction and/or UE location log (BD/UE LOG) 1440 which associates beam directions with the location (acquired during communication with the UE 10) of all UEs it has communicated with over some time period. This log 1440 can be analyzed using a beam direction and/or UE location log analysis to identify beam directions with a large variation in UE locations, consistent with an RIS being present in that beam direction. In an example, the locations of UEs may be estimated by the BS 10 for each UE while it communicates with it. In another example, a self-reported UE location may be refined by additional estimates performed by the BS.

Furthermore, the RIS 20 may comprise at least one of the following components or functions:
i. A reconfigurable surface (REC-SF) 270 which may be a multi-element electronically controllable surface which can be set to a number of configuration “states” each of which result in a different redirection pattern of radio waves of the frequencies associated with the communication. Such redirection could include at least one of:
   reflection with a given reflection angle;
   transmission;
   focusing or defocusing;
   generation of multiple beams;
   refraction with a given refraction angle (this option can be important to allow for communications, e.g., within a building); and
   absorption (this option can be used to reduce noise, and/or isolate a given environment).

A configuration state may be represented by a discrete number of state identifiers (e.g. state 1, state 2, state 3), or a collection of signal characteristics as a representation of the redirection pattern (e.g. (desired) reflection angle, focus point, number of beams, absorption/dampening factor, etc.)

The configuration state may also be the individual state of each element in a multi-element RIS which may be represented as a bitmap (e.g. identifying on/off state of each element) or a multi-dimensional array (e.g. identifying the phase shift, absorption, focus information, angle information, etc. of each element). Elements within a RIS may be electronically controllable (to change their individual state and/or desired properties), but may be also be physically controlled (e.g. by motors to physically control the angle of the RIS). For control of optical communication, the RIS may also have elements consisting of lenses of which the focus, opacity, curvature, polarization/filter state and reflection angles may be (individually) controlled.

These configuration states may be controllable by an access device (e.g. base station) of the wireless network by indicating the desired state, whereby the RIS reconfigures the elements of the RIS in such a way to achieve the desired state, or by sending control information with detailed (re-)configuration parameters (e.g. for each element in a multi-element RIS individually) from the access device to the RIS to reconfigure the RIS to its desired state.
ii. An RIS control module (RIS-CM) 260 configured to set the state of the reconfigurable surface 270 when commanded e.g. by the RIS communication module 110 of the BS 10. The RIS control module 260 may store a current state of the reconfigurable surface 270, that is currently set as RIS state. In addition, the RIS control module 260 may comprise an optional state cycling (ST-CYC) ability or function 2610 to perform state cycling on initial power-up, whereby it periodically switches its state to random widely differing states. This behavior may be suppressed when the RIS 20 is successfully registered with one or more networks and/or being controlled by an access device, or this function may continue to be carried out when the RIS 20 is not being commanded, in order to prevent the RIS 20 from being used as a passive surface by BSs. A goal may be to prevent others (e.g. BSs from network operators that do not have a usage agreement with the RIS owner) from using it as a passive surface. Another option is that the RIS 20 keeps changing states and only when the network decides, it configures its state according to the network's needs. Or, the network (e.g. BS 10) controlling the RIS 20 might know the schedule of the RIS states, e.g., the RIS 20 provides the BS 10 with its schedule for the period of time the BS 10 has rented the RIS 20, and use it to pick the right communication time slots to use the RIS when it is in particular desired states.
iii. RIS metadata (RIS-MD) 220, which includes information about the RIS (e.g. for deriving the capabilities of the RIS and its control by a network). This includes at least one of:
   Identity information (e.g., this information may be entered by an installer).
   Location and orientation (e.g., this information may be entered by an installer of the RIS 20 or RIS sensors (RIS-S) 250 that determine the location and 3D orientation and may automatically communicate it e.g. during a registration process);
   A set of configuration states (e.g., a set of discrete or possibly continuous state values, which may be represented as the way that incident radio waves incoming on the surface at a specific angle are transformed into outgoing radio waves, including direction, focusing etc. ; the states may be organized into a topological map (the RIS state topological map) showing which states are “adjacent”, i.e., give results, such as beam directions, which are the most similar, to enable performing a local search for an optimal communication path starting from a start RIS state);
   A default RIS state (e.g., the default state of the surface (the state the RIS 20 sets itself to when there is no commanded state; the RIS 20 will probably default to a specific state either when unpowered or when not commanded to adopt some other state (these may not be the same); the network may need to know this default state, as it is likely to be in this state prior to the network commanding it to some state optimized for communication (unless the RIS 20 is set to perform “state cycling” to prevent its use as a passive surface, in which case it will have a random and changing state));
   A speed of reconfiguration surface switching (the RISs may be able to switch their state as rapidly as possible, since slow switching would interfere with the ability of a BS to rapidly set up high bandwidth, reliable communications with a UE, in particular, a mobile UE, using that RIS and certainly to search for a communication path by cycling through the states of the RIS; the speed of state switching for the RIS 20 may indicate the number of states it is able to search through in a reasonable time if it is required to search for a communication path; or it may separately indicate a speed or time duration for being commanded from one state to another during operation);
   Authentication, control and query methods (e.g., a control method by which a signal sent to the surfaces sets them to a specified state (which are one of a set of categorical values or a small number of continuous values); and/or an authentication method, by which a control signal sent to the RIS 20 can be determined to be sent by a valid originator; the authentication method may also ensure the freshness of the command; during the registration process some form of command validation may be established, for example security keys should be exchanged, so that the RIS 20 can in the future determine that any commands sent to it that it enacts actually originate from an authenticated source that has permission to command it;);
   A network control prioritization procedure (e.g., priority allocated to the control of the RIS according to the network operator, or BS identity); and
   Costs (e.g., if there is a cost associated with the control of the RIS 20 (that is charged by the owner of the RIS 20 to a network which controls the RIS 20), then this can be derived by the network e.g. both in terms of quantity and schedule (e.g., pay per use, fixed fee, time-of-day based pricing, etc.)).
   Device Type (e.g. reflective RIS (which allows signals to be reflected to the UEs on the same side of the base station (BS)), transmissive RIS (which allows signals can penetrate the RIS to serve the UEs on the opposite side of the BS), or hybrid RIS (where the RISs have a dual function of reflection and transmission), which may also include information about e.g. number of individual sub-elements/panels, which materials used, physical dimensions/size of the device).
   Capabilities (e.g. radio/communication capabilities, relay capabilities (e.g. support for/compatibility with IAB relay, smart repeater, ProSe relay), number/type of sensors, characteristics and (relative) positions of RIS elements, maximum/minimum reflection angles, supported and/or non-supported frequencies or frequency ranges, supported reflection angles, (number of) motors to physically control the angle of the RIS and/or elements of the RIS and the Degrees of Freedom they allow).

In addition, the RIS 20 comprises an RIS communication module (RIS-COM) 210 which can receive commands and queries and return results. The RIS communication module 210 may include at least one of:
An RIS Transmission and Reception system (RIS-TRX) 2110 which may use the same wireless communication system as the RIS-controlling network (e.g., BS 10), e.g., 5G NR but may include the sending and receiving of messages via other wireless communication systems or via the internet, connected locally using Wifi, Ethernet, Bluetooth or the like. In order to achieve seamless use of these RISs within the process of communicating with the UE 40, the state switching commands to be communicated with the RIS 20 may be transmitted or routed through the same communication network via which the BS is seeking to set up a communication path to the UE 40. However, other means of communicating with the RIS 20 (e.g., via an internet protocol, via a fixed internet link, Wifi, Bluetooth or the like) can be used, but may introduce a delay in the process of setting up communications with the UE 40.
An RIS registration capability (RIS-REG) 2130 configured to set up registration of the RIS 20 in the RIS installation database 30.
An RIS command/query validation and acceptance (RIS-CQ-V) capability 2120 which may including a validated network list (e.g., a list of networks or BSs which have been validated for control of that RIS 20), an optional RIS network priority list (giving e.g. the negotiated priority number of each validated network), an optional additional information needed for acceptance of a command/query from a network (such as a “Network Blacklist”), and an optional capability to initiate registration with one or more networks (e.g. RIS registration request capability).

Further, the RIS 20 comprises RIS current information data (RIS-CID) 230 that may include a current RIS state, which may indicate the configuration state currently set for the reconfigurable surface 270; an optional current controller priority number which is set to the priority number of a current controller (if not commanded, this flag may be set to zero (NULL)); an optional currently commanded flag indicating if the current state of the RIS 20/reconfigurable surface 270 is being currently commanded (e.g. by another network/BS); an optional time during period timer (e.g. a timer and timer value indicating for how long the current state has been commanded by a network); and that may include an out of operation flag (which is set to “False” if the RIS 20 is correctly powered and able to set its state to one commanded or to “True” if the RIS 20 is currently unable to set its state to a commanded one).

Optionally, the RIS 20 may comprise a network usage log (NU-LOG) 240 which stores a total time that each network/BS has used the RIS 20/reconfigurable intelligent surface 270 in the last time period and optionally a complete listing of times and lengths of usage of the RIS 20 for each network, during a defined time period.

As a further option, the RIS 20 may comprise RIS sensor(s) (RIS-S) 250, e.g., a set of sensors which collect the location and orientation of the reconfigurable surface 270. As an example, the RIS 20 may comprise of a GPS/GNSS module to determine its location and/or receive clock synchronization information, and may e.g. contain a gyroscope and/or compass to determine its orientation.

Optionally, the system may comprise a published RIS installation database (RIS-I-DB) 30 in which details of all RIS installations and a means of requesting registration for them are stored, whose functionalities include:
i. means/functions for entering new RIS installations into the RIS installation database 30; and
ii. means/functions for querying the RIS installation database 30 according to a location and/or according to an RIS type and/or according to RIS properties.

### SMART REPEATERS

In general RF signal repeaters share much of the same properties as reflective intelligent surfaces, but use an RF transmitter and RF receiver frontend to rebroadcast the RF signals rather than using reflection of signals to propagate the RF signals. However, one of the benefits of a RIS that a gNB can dynamically control the state of the RIS. In another embodiment, a smart repeater interface can be based on the proposed system and method.

RF repeaters are devices that “repeat” the signal received from an access device (e.g. gNB), thereby extending its range. A preliminary evaluation indicate that performance improvement can be achieved by adding side control information (on/off, timing, spatial Tx/Rx), i.e. by making RF repeaters more smart. In that sense, smart repeaters may not just include the RF layer of an access device (e.g. gNB), but also the PHY layer for the control plane, and may e.g. include a communication module or UE similar to a RIS communication module 210 or RIS-UE 50 for sending and receiving information to an access device. The access device (e.g. gNB) can then steer the smart repeater with parameters such as the timing configuration (UL/DL), beamforming, or on/off.

The steering capabilities of a smart repeater and an RIS are expected to be similar. As already discussed above, the access device (e.g. gNB) can command the RIS to setup a given reflection pattern for a given period. This is similar to configuring the beamforming in smart repeaters. The access device (e.g. gNB) can control the RIS for some timeslots, which is similar to providing a given timing configuration to a smart repeater. Furthermore, the RIS is by default off, and thus, it only operates when the access device (e.g. gNB) is using it.

From this point of view, the embodiments in this disclosure may also be implemented in smart repeaters or a combination of RISs and smart repeaters. To this end, RIS 20 in the embodiments in this disclosure can also be a smart repeater. Hence, the term RIS 20 can be replaced by smart repeater 20 in the embodiments in this disclosure. In the device architecture, the reconfigurable surface (REC-SF) 270 can be replaced with a transceiver comprising a RF receiver frontend and an RF transmission frontend, coupled to one or more antennas, whereby the controllable states may include states/settings to control the on/off state, beam steering (e.g. number of beams, beam direction), transmission power and/or frequency and/or timings of transmitted RF signals (e.g. configurable delay), and whereby redirection patterns may include generation of multiple beams, focusing or defocusing a beam, directing a beam in a certain angle (whereby the angle may be in relation to a reference line or magnetic north, or an angle between an incoming beam and an outgoing beam (i.e. similar to deflection/refraction angle)), amplifying the incoming signal (e.g. by providing an amplify gain in a command), delaying the signal (e.g. by providing a delay time or specific timing for outgoing signals in a command). The transceiver may be the same as the RIS transmission and reception system (RIS-TRX) 2110 or may reuse/share components within the RIS-TRX 2110, or it may be a separate subsystem.

### RIS REGISTRATION AND CONTROL PROCEDURES

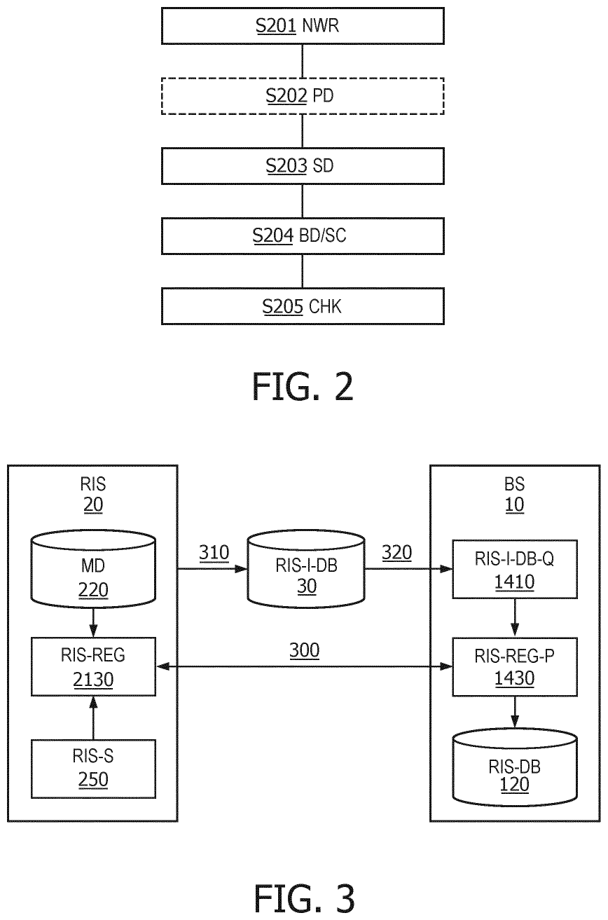

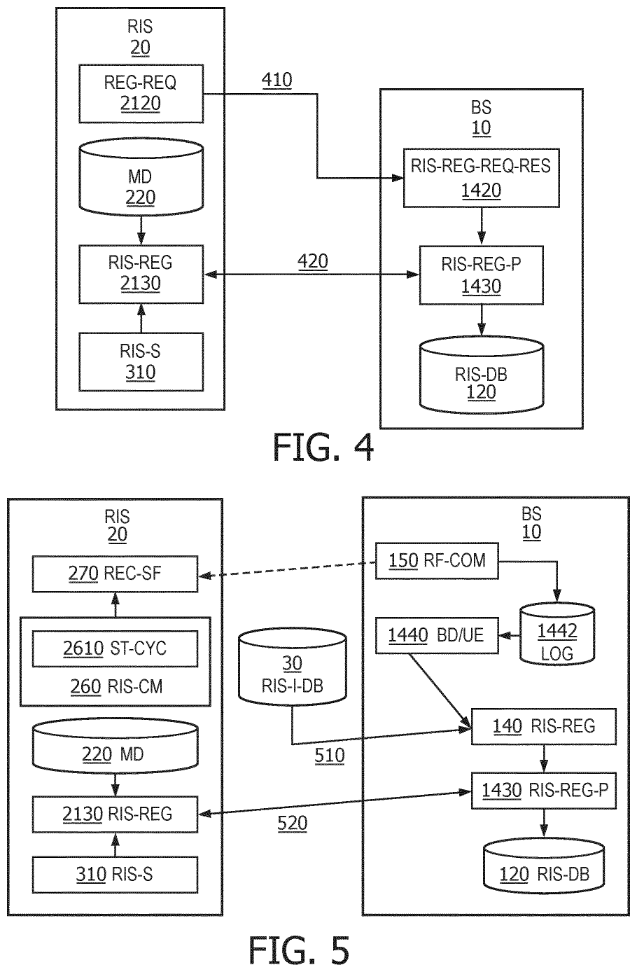

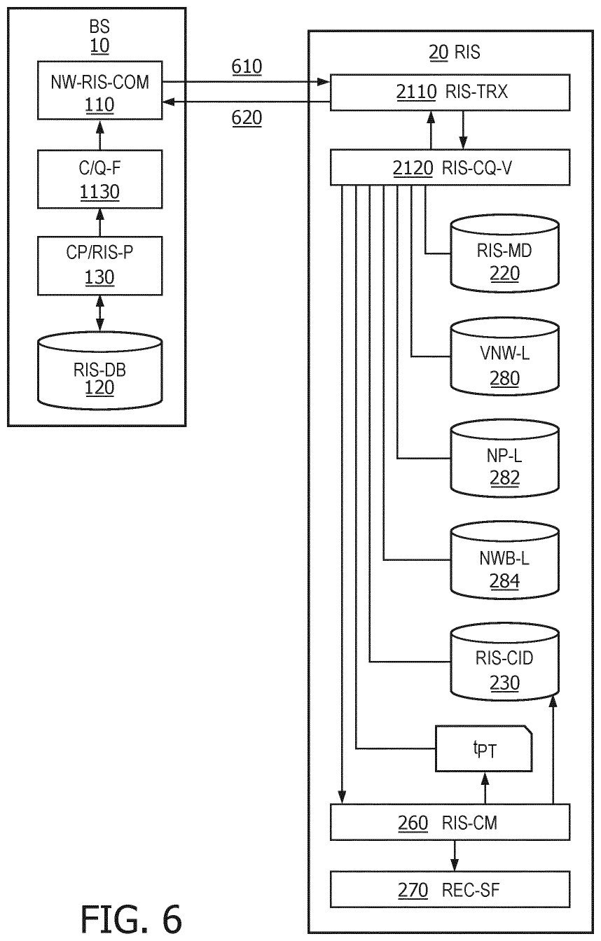

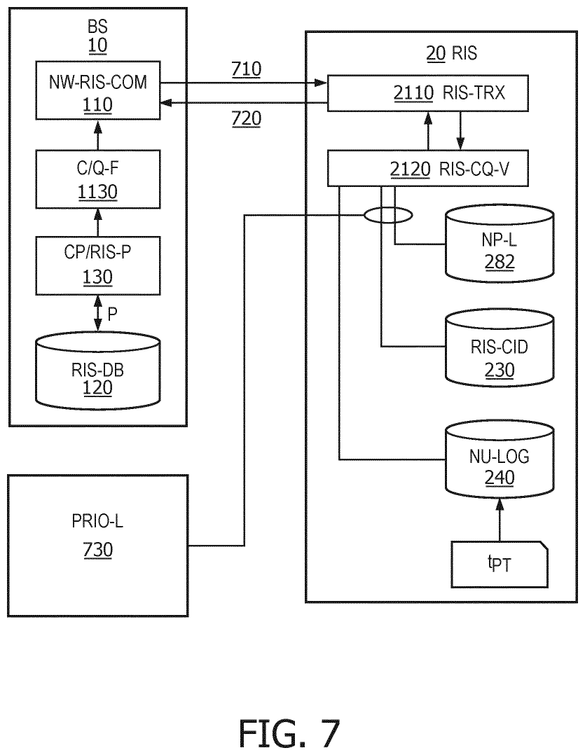

FIG. 2 schematically shows a flow diagram of an RIS registration and control method according to various embodiments.

In a network registration (NWR) step S201, the network (e.g., BS 10) registers the RIS 20 and determines all parameters needed for its control, while the control is performed by validated and accepted commands and queries.

In a subsequent path determination (PD) step S202, the network/BS determines an optimal communication path with a UE (e.g., UE 40), including directing the path of a beam-formed (directed) signal towards the RIS 20 and setting the RIS state so that the beam is correctly redirected towards the UE. The network/BS may be triggered to communicate with the UE via a RIS and/or initiate a path determination step and/or configure/command a RIS, if the LOS signal between the access device and UE or between the RIS and the UE has deteriorated or experiences a drop (e.g. due to an obstacle) or has a peak in signal strength (e.g. due to a signal being reflected via a RIS). This may be discovered through measurement reports or CSI feedback from the UE and/or from the RIS (e.g. measurement reports or CSI feedback related to the link between RIS and the UE). In a particular example, if the measurement reports show (e.g. through its RSRP feedback or UE RX-TX feedback) that the UE is moving in a certain direction, but adjusting the beam towards the UE does not improve or actually deteriorates the signal quality/strength, it may indicate that the UE is obscured by an obstacle. This may trigger the network/BS to trigger a local beam search or other communication/beam path establishment process (as described in further embodiments) to determine a RIS and/or a state of a RIS to set up a communication path to the UE via a RIS.

In a following state determination (SD) step S203, the network/BS queries the RIS 20 to determine its current state, including whether it is commanded by another network and optionally, what the current commanded priority level is.

Then, in a beam directing and state commanding (BD/SC) step S204, if the path found in step S202 is a path which achieves good quality communication, and the network/BS is able to command/control the RIS 20, the network/BS directs its beam-formed (directed) signal towards the RIS 20 and commands the RIS 20 to the relevant state. This procedure may be repeated as the UE moves, or as large objects in the environment causing obstruction of RF communication path(s) move.

Finally, in a checking (CHK) step S205, the network/BS may routinely checks whether the RISs in its RIS database 120 remain operational.

Hence, newly installed RIS systems can be registered such that the network/BS has an ability to command them to desired states, including discovery methods if a formal registration process for the RIS is not available. This provides an ability to rapidly plan communication paths which include relevant RIS systems, avoiding exhaustive real-world search through BS beam directions and RIS states. Moreover, a registered RIS that is no longer functional can be removed from possible communication path(s) with end users.

FIG. 5 schematically shows an RIS discovery and registration process according to an embodiment with autodiscovery of the RIS 20 in a locality method.

When the RIS 20 is installed and powered up but is not yet registered by any network, its initial behavior of the RIS control module (RIS-CM) 260 may be set to the state cycling (ST-CYC) function 2610 where the RIS 20 periodically changes its state to one selected at random between separated states.

In addition, owner(s) of the RIS 20 may set the RIS 20 to activate this state cycling function 2610 when not being controlled by a network/BS (rather than to a default RIS state) in order to (for example) prevent any networks from using the RIS 20 as a passive surface without appropriate payments or permissions, which might otherwise be possible if the state were predictable.

When the RIS 20 is registered and controlled by at least one network, the RIS 20 can adopt a state commanded by a registered network. The RIS 20 may also be operating the state cycling function 2610 whereby it is randomly changes its state when not being actively commanded to a state. In both cases a beam pointed at the RIS 20 from an unregistered BS will be redirected in different directions at different times.

A network (i.e., BS 10) with which the RIS 20 is not currently registered or which it is currently not actively commanding may note/determine, using its beam direction/UE location log (LOG) 1442 analyzed by its beam direction/UE location log analysis (BD/UE) 1440, that beam paths to certain end UE locations can vary significantly when the BS beam is pointed in a specific direction. That is, a certain beam direction is associated with a log of end user/UE locations which vary significantly at different times. Or, alternatively it may note that a BS beam pointed in a specific direction gives a particular variable (e.g. intermittent and periodic) connectivity to a particular stationary UE. This analysis may indicate that the RIS 20 is present in that beam direction. The corresponding information stored in the beam direction/UE location log 1442 may have been obtained from the RF communication capabilities (RF-COM) 150 based on a beam directed to the reconfigurable surface (REC-SF) 270 of the RIS 20 (e.g. based on a collection of measurement reports from UEs or from RISs registered to the BS 10, which may include e.g. RSRP values per beam/SSB index). Based on this information/analysis the network (i.e. BS 10) may decide which RIS to select and/or whether or not to register/connect with the RIS 20 and/or decide to transmit a command/query to the RIS 20.

Noting the location and/or beam direction of the newly identified RIS 20, the network can seek a means to establish registration with the RIS 20 by a wide variety of methods, including search in databases, sending a direct request using a wireless communication protocol (e.g. a discovery protocol), sending communications to the companies or individuals located in that building, and so on. In the example of FIG. 5, the RIS registration capability (RIS-REG) 140 of the BS 10 obtains 510 the unique identifier of the RIS 20 (and optionally the method of requesting registration) from the RIS installation database (RIS-I-DB) 30 based on e.g. a result of the beam direction/UE location log analysis

Once the RIS registration method has been obtained, the RIS metadata 220 of the RIS 20 may be supplied to the BS 10 by using a negotiation and validation procedure 520 between the RIS registration process capability (RIS-REG-P) 1430 of the BS 10 and the RIS registration capability (RIS-REG) 2130 of the RIS 20. The RIS metadata 220 may then be entered into the RIS database 120 of the BS 10. If the RIS 20 comprises RIS sensors (RIS-S) 310, the location and/or orientation of the RIS 20 can be collected from these sensors 310 and communicated as part of the RIS metadata 220.

The BS 10 may negotiate the ability to control the RIS 20 using its RIS registration process capability 1430 to obtain validation, a priority for the RIS use and optionally a payment price and/or schedule for use of the RIS 20. Once this negotiation is successfully concluded, the command/query validation process is agreed as before. This is a validation process for subsequent commands or queries.

### ACTIVELY SEARCHING FOR COMMUNICATION PATH VIA RIS

Given the large search space introduced into the beam search by one or more RIS with possible option of communicating with a UE, traditional beam search techniques, expanded by commanding cycling though the states of the RIS, may introduce significant delays. Therefore, an improved beam path determination (e.g., BS beam direction and RIS state) for communication with a UE at a certain location is proposed. As mentioned earlier, a BS may be triggered to initiate a path determination, e.g. if the LOS signal between the access device and UE or the signal between the RIS and UE has deteriorated or experiences a drop (e.g. due to an obstacle) or has a peak in signal strength (e.g. due to a signal being reflected via a RIS). This may be discovered through measurement reports or CSI feedback from the UE or from the RIS. Additionally or alternatively, the network/BS may be triggered to initiate a path determination step, if it receives a message from/via a RIS that a UE has lost connection and/or may wish to communicate via a RIS, e.g. after receiving discovery messages over sidelink from the UE (as described in further embodiments).

The base station may perform a real-world active search for the best communication path to the UE, possibly by cycling through the states of the RIS (or the use of its elements one at a time) and beam directions, until it determines an RIS state which achieves communication which is good enough for its operative requirements. If the RIS has many possible states (or elements), this kind of search may not be fast enough for routinely establishing communication. Therefore, using this real-world search may be restricted to the first few times that the network uses an RIS, subsequently one of the other suggested processes would be used.

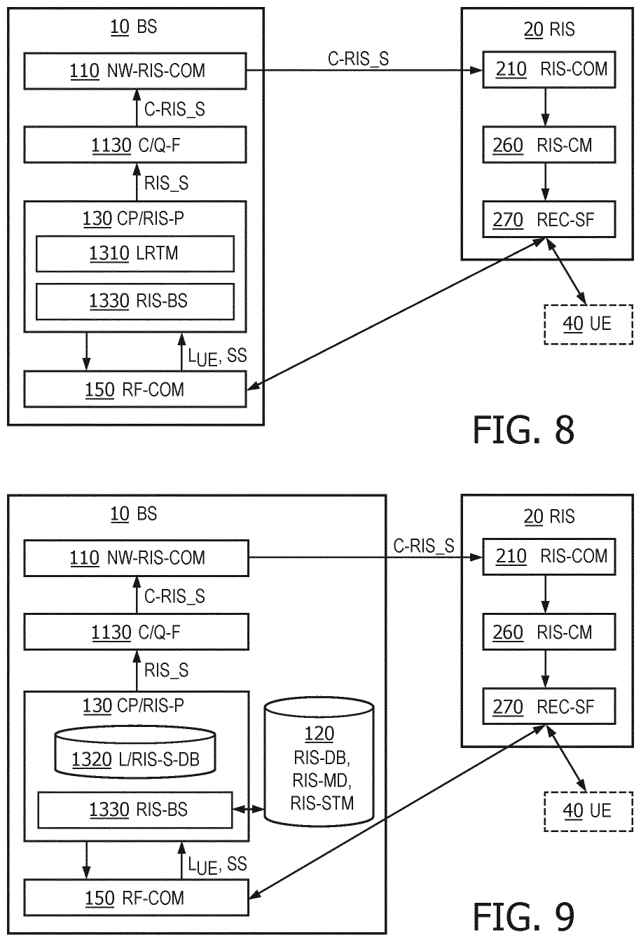

FIG. 8 schematically shows a communication path establishment process according to an embodiment with a real-world exhaustive search.

The proposed beam path establishment process enables the network to determine the location of a UE 40, to determine if an RIS inclusion is appropriate for communication with that UE 40, to determine which is the optimal state for the RIS to be set to in order to assist in that communication, and to determine the correct beamforming direction either directly to the UE 40, or to a passive surface that redirects to the UE 40 or to the RIS now set to the correct state to transmit/reflect the beam to the UE 40.

In an embodiment of FIG. 8, a transmission ray-traced modelling supported beam search is proposed.

The network (e.g., BS 10) maintains a 3D local radio transmission model (LRTM) 1310 of the environment, including the known RISs and the effects of their states, and performs a rapid simulated optimization process (e.g., by the communication path and RIS planning module (CP/RIS-P) 130) using this model to determine a correct beam direction and RIS state selection to achieve the best communication with a UE located at a specific location.

Once a suitable communication path has been found by the model, a small real-world local search can then be performed e.g. by the RIS beam search capability (RIS-BS) 1330 to optimize the link.

The communication path and RIS planning module 130 supplies a next RIS state (RIS-S) to the command/query formatting for validation (C/Q-F) function 1130 which generates a command (C-RIS-S) for the next RIS state and supplies it to the network to RIS communication system (NW-RIS-COM) 110. This command is then transmitted to the RIS 20 and received by the RIS communication module (RIS-COM) 210 which validates and forwards it to the RIS control module (RIS-CM) 260. The RIS control module 260 controls the state of the reconfigurable surface (REC-SF) 270 of the RIS 20 according to the received command, so that the reflection or refraction or redirection of the transmission beam from the BS 10 is modified accordingly.

The quality of the resulting communication paths as determined by a signal strength (SS) or another quality parameter obtained e.g. by the RF communication capability (RF-COM) 150 together with the location (L_{UE}) and/or measurement reports of the UE 40 and/or measurement reports/CSI feedback of the RIS (e.g. of the link between the BS and the RIS or the link between the RIS and UE) may then be used to update the model. Additionally, or as an alternative embodiment of FIG. 8, the network selects a RIS state which enables a wide angle scattering of an incoming signal/beam and/or a wide beam (or even an omnidirectional signal) is propagated by the RIS towards UE 40. A UE 40 may receive such reflected signal and may perform measurements on the received reflected signal and report the measurements (directly through line-of-sight connection or through an indirect path via a RIS or other relay device) to the network/BS. The UE 40 may also report its estimated position (e.g. obtained through other means such as GPS, or TDOA measurements from nearby base stations). The RIS may perform measurement reports on the uplink signals received from the UE 40. The RIS state selected by base station and commanded to the RIS may be selected in such a way to reduce the width of the propagated signal/beam and hence use a less wide beam towards the UE 40 and/or change the angle of the beam towards the UE, which may report its measurements again. By changing the angles and/or further narrowing the beam based on the feedback/measurements from the UE 40 using a feedback loop, a suitable communication path between the BS 10 and the UE 40 via the RIS 20 can be determined.

FIG. 9 schematically shows a communication path establishment process according to an embodiment with beam path memory and limited local beam search.

The communication path and RIS planning module (CP/RIS-P) 130 of the BS 10 can remember the path found for the UE 40 in the specific location (L_{UE}) and store it in a location/RIS state database (L/RIS-S-DB) 1320. This works similarly for the embodiment of FIG. 8 with the 3D local radio transmission model 1310.

If, in the past, this model has calculated a path and using this path by the BS 10 gave good results, it can be stored in the database 1320. Then, when a future UE is found near this location, the previous beam direction and state of the reconfigurable surface (REC-SF) 270 are retrieved and used, optionally with some further optimization (e.g., using local search in the RIS states) and updating of the parameters used to communicate to that location.

A limited search for optimal paths in the real-world is performed, having stored the results from past uses of the RIS 20, that is, the RIS states for communication with specific locations. From this start it can initiate a limited local search process through RIS states. Using the RIS state topological map (RIS-STM), the local search can be performed from the initial selected state.

Pilot uplink signals from the UE 40 may be used to determine its location (L_{UE}) within the space.

If beamforming in that direction directly (not via the RIS 20) is determined to be not good enough and a similar (but not necessarily identical) location has been served by the (nearby) RIS (e.g. RIS 20) in the past, the RIS state that was used for communicating with that location in the past is retrieved and the RIS state is set to that value, whilst beam forming at the RIS 20.

Using the RIS state topological map for that RIS, stored in its RIS metadata (RIS-MD) which may be stored in the RIS database (RIS-DB) 120, a local search through the adjacent states is performed as described in the embodiment of FIG. 8 and the signals quality is determined (e.g., based on the signal strength (SS) or another quality parameter).

When an adequate signal quality has been achieved (e.g., a predetermined threshold has been reached), the corresponding RIS state is used to communicate with the UE 40 and the RIS state and UE location (L_{UE}) may be stored in the location/RIS state database 1320 for that RIS 20.

### FLOW DIAGRAM FOR RIS ENABLED COMMUNICATION

FIG. 11 schematically shows a flow diagram of a process for an RIS enabled communication according to various embodiments.

The process is designed to enable the set up and command of RISs within a radio communication system such as 5G/5G-NR.

An initial RIS discovery and registration process (RIS-D/R) S1101 enables the registration of a newly setup RIS with a network and the validation of the network with the RIS, thereby establishing the properties of the RIS with the network and enabling the network to validly command the state of that RIS.

This may be achieved by an RIS installation database registration method where a new RIS looked up in a global RIS installation database and a registration method is retrieved, or by an RIS request for registration method where the RIS sends communication to local networks when first switched on and sends the registration method, or by a registration by autodiscovery of the RIS in a locality method where the BS notes local transmission paths with variable properties associated with an RIS and seeks registration through a variety of means (as explained for example in the embodiment of FIG. 5).

Then, in an RIS query and command process (RIS-Q/C) S1102, the network and/or BS specifies the command or query to be sent to the RIS using e.g. the RIS query and command capability, formats the command/query using e.g. the command/query formatting for validation function, transmits the command/query to the RIS using e.g. the network/BS to RIS transmission and reception system, and receives any response from the RIS using the network/BS to RIS transmission and reception system. Additionally, the RIS receives the communicated query or command using the RIS communication module, checks the command/query for validity and if the command/query is to be accepted using the RIS command/query validation and acceptance function, and if a command is accepted, the RIS command module sets the reconfigurable surface of the RIS to the commanded state, or if a query is accepted, the RIS returns the RIS current Information data including the RIS state.

In a network control prioritization process (NC-PRIO) S1103 during registration, with a subsequent change or dynamically with a command, the RIS stores the priority of a network that commands the RIS in the RIS network priority list.

If the RIS is not currently commanded and receives a command from a network, it determines that commanding network's priority and stores it as the current controller priority (e.g. indicated by a number as an index in an ordered list) in the RIS current information data, and then carries out the command.

If the RIS is currently commanded, it compares the priority of a new commanding network with the priority of the currently commanding network (stored as the current controller priority) and if the new priority is higher, the RIS ceases the command from the previous network and allows the new network to command.

Alternatively, even low-priority networks may be given a minimum time period for their command, and the change in command is only enabled after this minimum command time has been reached.

In a communication path establishment process (CP-EST) S1104, the network and/or BS seeks to establish a communication path with a UE, where this path could include one or more RIS (where the RIS database indicates that that RIS is operative and that the network has command rights).

This may be achieved by an exhaustive search through beam forming directions and RIS states to find the best communication path to a UE, and when found, the BS directs its beam at the RIS and commands the RIS to the correct state.

Alternatively, as indicated in the embodiment of FIG. 8, a transmission ray-traced modelling supported beam search may be applied, where a transmission modelling within a local radio transmission model of the local environment is used to search for suitable beam paths (e.g., BS beam direction and RIS states), followed by a fine tune using local search in neighboring RIS states retrieved from an RIS state topological map. When found, the BS directs its beam at the RIS and commands the RIS to the correct state.

As a further alternative, as indicated in the embodiment of FIG. 9, results of previous beam direction plus RIS states and UE location are stored in a location/RIS state database. For a new UE location, the nearest entry for this location is searched in this database and if sufficiently close, the stored settings for BS beam direction and RIS state are used and fine-tuned with a local RIS state search. When found, the BS directs it beam at the RIS and commands the RIS to the correct state.

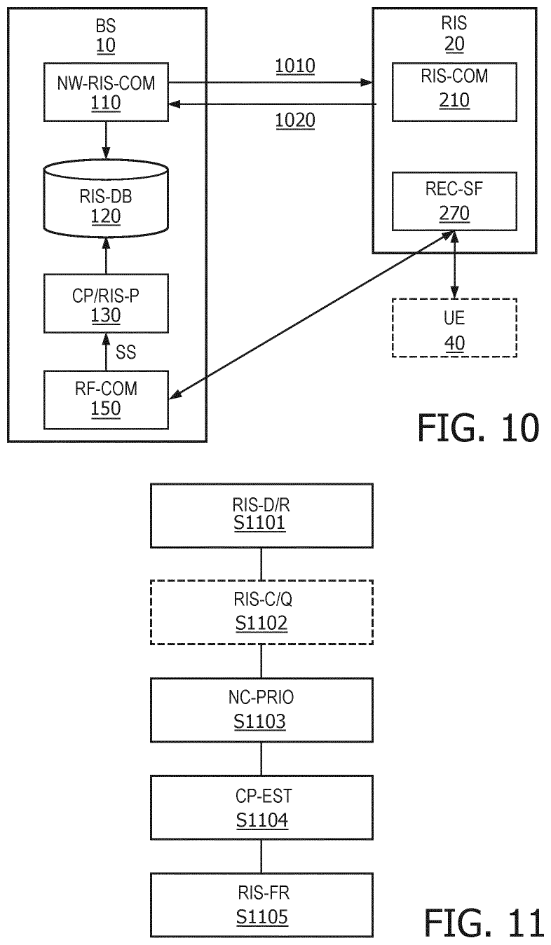

In an RIS failure recognition (RIS-FR) process S1105, as indicated in the embodiment of FIG. 10, the network and/or BS enters into its RIS database that an RIS is inoperative if the RIS returns an out of operation flag set to “True” or if the RIS returns no response to a query sent to the RIS or if communication signal strengths and/or other signal quality indicator(s) indicate no actual change in the RIS state.

Optionally, an RIS that has reliably determined the presence of an end-user UE in this way may report this to the database/gNB such that the gNB can make use of the RIS's ability to now focus the gNB's beam on this UE.

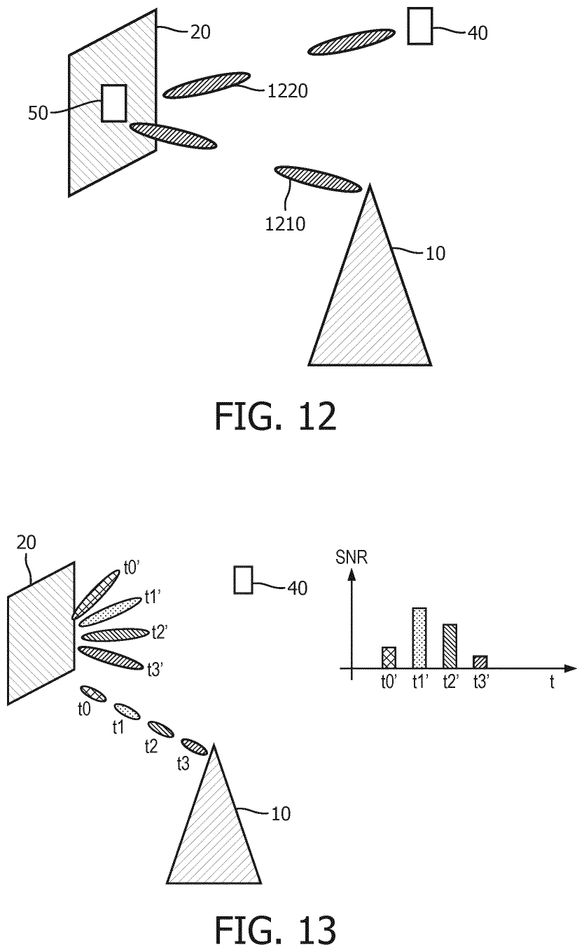

FIG. 12 schematically shows a first example of an improved beam steering process according to an embodiment.

In the first example, the RIS-UE 50 announces its RIS capabilities (e.g. using information provided through ProSe/sidelink Model A discovery) so that an UE 40 with bad connectivity can discover it. Alternatively, the UE 40 with bad connectivity can try to discover the RIS-UE 50 or other RIS-UEs (e.g. using information provided through ProSe/sidelink Model B discovery). Once the RIS-UE 50 and the UE 40 have found each other, if authorized, the RIS-UE 50 and the UE 40 may establish a communication link e.g. via a PC5 interface and they may also identify their specific direction (e.g. beam angle/path) by pairing their beams. The RIS-UE 50 can then send this information (i.e, the beam direction towards the UE 40) to a controlling gNB 10. The gNB 10 knows where the RIS 20 of the RIS-UE 50 is located and in which direction it has to form its beam to reach it. Furthermore, the gNB 10 also knows now the location of the UE 40 respect to the RIS-UE 50, since the RIS-UE 50 reported the beam direction from the RIS-UE 50 towards the UE 40. Thus, the gNB 10 can determine the configuration (e.g. reflection/refraction angle or redirected beam angle) of the RIS 20 to directly reach the UE 40. This is illustrated in FIG. 12 where the RIS configuration refers to a reflection/refraction/redirection angle as achieved e.g. by an orientation of the RIS 20 in space.

### IMPROVED BEAM STEERING BY RIS PROVIDING SSBs AND SYNCHRONIZATION AND SYSTEM INFORMATION

FIG. 13 schematically shows an example of an improved beam steering process according to another embodiment.

In the this example, the gNB 10 sends system information (SI) towards the RIS 20, wherein the system information may be similar to synchronization signals of a physical broadcast channel (PBCH) used to broadcast basic system information within the cell of a cellular radio access network. The access device, the gNB in this case, directly from a CU or through a DU, drives the RIS in a way that the RIS seems to distribute its own synchronization signals. The system information can include a primary synchronization signal (PSS), a secondary synchronization signal (SSS), and a master information block (MIB) broadcasted in the PBCH channel. To emulate different synchronization signal bursts or blocks (SSBs) used in 5G and broadcasted in different directions through different beams, the gNB 10 sends such RIS SSBs towards the RIS 20.

For instance, in FIG. 13, the gNB 10 has sent four RIS SSBs at times t0, t1, t2, and t3 towards the RIS 20 using a single beam pointing towards the RIS 20. The gNB 10 may change the RIS state in synchronism with the time that the RIS SSBs reach the RIS 20 in such a way that the RIS SSBs are reflected/refracted/redirected in different directions as illustrated in FIG. 13, where at time t0′ the RIS SSB is broadcasted using the highest beam direction, at time t1′ the RIS SSB is broadcasted using the second highest beam, at time t2′ the RIS SSB is broadcasted using the second lowest beam direction, and at time t3′ the RIS SSB is broadcasted using the lowest beam direction.

When the UE 40 receives the RIS SSBs, the UE measures the signal-to-noise ratio (SNR) as illustrated in the time-dependent diagram on the right side of FIG. 13. This diagrams shows that the first SSB broadcasted at time t0′ has been received with the second lowest SNR, the second SSB broadcasted at time t1′ has been received with the highest SNR, the third SSB broadcasted at time t2′ has been received with the second highest SNR, and the fourth SSB broadcasted at time t3′ has been received with the lowest SNR. The UE 40 can select the SSB with the highest SNR to establish a communication link with the gNB 10 through the RIS 20. This can be achieved by assigning an individual parameter (e.g., time or frequency or preamble or code) to each of the beams and using this parameter for designating a beam during the initial random access procedure.

In an example, the gNB 10 can keep sending RIS SSBs towards the RIS 20 and the gNB 10 can keep switching the RIS state accordingly to keep emulating the synchronization signals. If the UE 40 moves, the UE 40 can inform the gNB 10 about the received SNR for each of the RIS SSBs so that the gNB 10 can adjust the RIS state accordingly to ensure a good connection between the gNB 10 and the UE 40 through the RIS 20. Note that the UE 40 may be able to differentiate SSBs before being reflected/refracted/redirected (times t0, . . . , t3 in FIG. 13) and after reflection/refraction/redirection (times t0′, . . . , t3′) because the SSBs before reflection/refraction/redirection will lead to an almost identical (uniform) SNR while the SSBs after reflection/refraction/redirection will exhibit a non-uniform SNR distribution.

In an example, the system information associated to the RIS 20, e.g., MIB or system information block (SIB1), may include information about the fact that the gNB 10 is transmitting this signal via the RIS 20. This can be, e.g., a single bit that can be either 0 or 1. The system information associated to the RIS 20 may also include information about the parent gNB 10 steering the RIS 20, e.g., it can include the physical cell identity (PCI) of the parent node. Such information can be used by the UE 40 to decide about joining/communicating through the RIS 20 or not.

### IMPROVING CSI AND REDUCING INTERFERENCE WHEN USING A RIS

In another embodiment, a channel state information (CSI) can be enhanced. In wireless communications, the CSI refers to known channel properties of a communication link. The CSI describes how a signal propagates from a transmitter to a receiver and represents the combined effect of, for example, scattering, fading, and power decay with distance, as obtained e.g. by a channel estimation process. The CSI makes it possible to adapt transmissions to current channel conditions, which is crucial for achieving reliable communication with high data rates e.g. in multiantenna systems.

Thus, CSI reference signals (CSI-RSs) may be used when the gNB transmits towards the UE to understand the channel properties and how good (or bad) the communication link is. The gNB may send CSI-RS and the UE receives these and reports their value. In an example, a CSI-RS may be sent every two resource block(s) (SSBs). The CSI-RS may be periodic, semipersistent or aperiodic (e.g., transmitted in a downlink control information (DCI) message).

In an example, zero-power CSI-RSs may be provided as time/frequency slots where the gNB informs the UE that nothing is transmitted. These slots can be used by the UE for interference management. Based on the received signals, the UE may select a most suitable precoding matrix for antenna steering for the gNB, e.g., by using given a codebook of precoding matrices. There may be two types of codebooks: type 1 is coarser (e.g. for single users) and type 2 is extensive (e.g. for multi-user multiple-input-multiple-output (MU-MIMO) systems). In the uplink direction, CSI may not be required, since the gNB can track the quality of the received signal and instruct the UE accordingly.

As an alternative option, sounding reference signals (SRSs) may be used in the present embodiment, instead of the CSI-RSs. SRSs are reference signals transmitted by the UE in the uplink direction and are used by the gNB to estimate the uplink channel quality over a wider bandwidth e.g. for scheduling purposes.

In the case of an RIS, the gNB may be interested in knowing the channel to the UE through the RIS.

In an example, an increased number of timeslots, e.g., n, may be allocated to transmit the CSI-RS when a UE connects through the RIS. For instance, n=3 slots. Although the reference signal may be identical at the transmission time for all n slots, the gNB may control the RIS in such a way that the RIS has slightly different reflection/refraction/redirection RIS coefficients in those n slots. For instance, for n=3, the first slot might use the reflection/refraction/redirection RIS coefficients and gNB-RIS beamforming that are currently considered as optimal, and for the other two slots slightly different reflection/refraction/redirection RIS coefficients and/or gNB-RIS beamforming may be used. The aim may be that the UE can help the gNB to identify in which direction (i.e., which reflection/refraction/redirection RIS coefficients) the RIS should be steered in order to keep a good connection and/or how the gNB beam should be steered towards the RIS.

The above procedure can be done for each resource block, or the configuration of beam/RIS might be slightly adapted for CSI-RSs transmitted in different resource blocks.

### ESTIMATING QUALITY OF BACKHAUL LINK INDEPENDENTLY FROM ACCESS LINKS

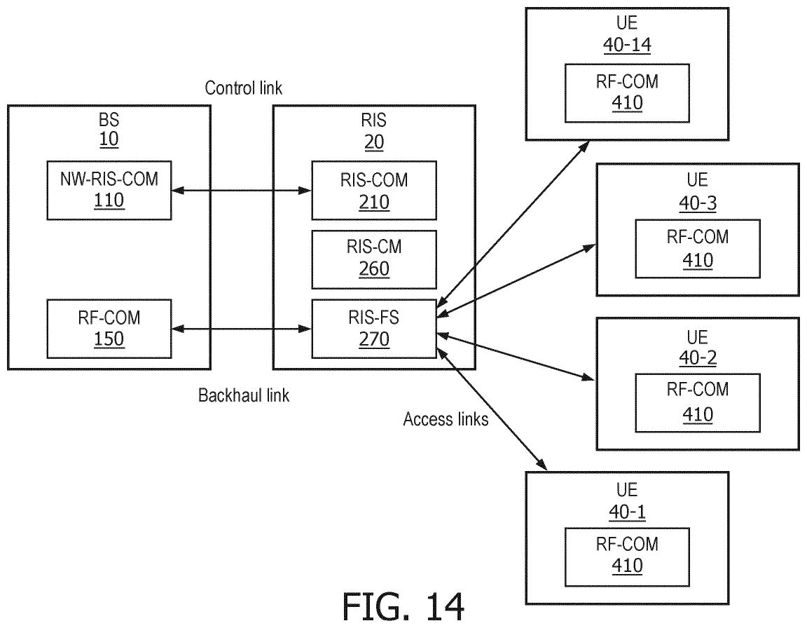

FIG. 14 schematically shows a network comprising a gNB 10 in communication with the control module of a RIS 20 (RIS-CM 260) (via a control link between the NW-RIS-COM 110 at the gNB and the RIS-COM 210 at the RIS) and in communication with one or more UEs 40 (via a backhaul link between the RF-COM 150 at the gNB and the RIS-FS 270 and via an access link between the RIS-FS and the RF-COM 410 of each UE).

When the gNB 10 communicates with a UE 40 via a RIS 20, the path passes over two links, the backhaul link and the access link, but only one set of CSI feedback, covering both links is received from the UE. In cases of poor link quality it can be unclear which link is the cause and should be adjusted. There is a need for a means of estimating backhaul link quality independently from the access link to each UE.

In some scenarios, the backhaul and control links operate in the same operating band. Thus in a first embodiment, the backhaul link shares the antenna array used by the control link between the gNB and the RIS control module (RIS-CM) 260. The shared beam is then steered according to the CSI dialogue between gNB and RIS-CM. When a gNB wants to communicate with a UE through the RIS, it allocates appropriate communication resources for the UE and establishes a CSI dialogue with it to steer the access beams. Since the backhaul link is managed independently via the RIS-CM CSI dialogue, the gNB may then account for the contribution of the backhaul link by assuming that it is negligible. This might be appropriate if the CSI dialogue with the RIS-CM reports a good channel or, at least, a channel with significantly better performance than reported by the UE CSI dialogue.

In this first embodiment, advantage is taken of the fact that the performance of the backhaul link is known from the RIS-CM CSI dialogue. Thus, in the uplink direction from the UE, the gNB can compensate for the backhaul by equalising the received signal according to, for example, the readings from the CSI signals transmitted by the RIM-CM to the gNB over the control link. This may provide some extra margin against link degradation.

Where the same band is used for uplink and downlink, as in TDD mode, for example, the gNB can also pre-equalise downlink signals, meaning that the UE receives signals that are essentially only degraded by the access link.

The scenario described in the previous embodiment is limiting. There is interest in being able to support multi-band repeater operation without requiring a multi-band link to the RIS-CM 260. There may also be applications in which, despite sharing the same band, the RIS-FS 270 and RIS-CM are served by different transmit/receive points or different gNBs and therefore require different beams. Thus, in a second embodiment, advantage is taken of the fact that the backhaul link can be shared by many UEs, each with their own access link. If the backhaul link does not have good quality, then the same channel degradations will be reflected in the CSI information from all UEs. This provides an indication to the base station that the fault is in the backhaul link, not the access links.

If it can be assumed that the backhaul link is of good quality, then the CSI information will say more about the access link so, to a good approximation, the contribution of the backhaul link to overall link quality can be ignored. This can be the case if the repeater and base station are both in fixed locations, for example. In other cases, when the repeater is moving, for example, or when the backhaul link needs to be first established, it cannot be assumed that the backhaul is of good quality and some means of deriving quality is necessary.

As an example of how this can work, for the downlink, the UEs 40-1, 40-2, 40-3, 40-4 all return CSI feedback in the form of a four-bit CSI index that indicates the modulation and code rate that the UE thinks it can successfully demodulate. A low number indicates a poor channel (with 0 indicating no ability to demodulate data), a higher number a better quality channel. Assuming that UEs all have similar demodulation capabilities, the different numbers can provide a measure of the relative performance of the backhaul link and the access links and, using a simple heuristic approach, the gNB can make a decision on which beam to adjust. For example, considering that the relay is there to provide good service to UEs out of direct range of the gNB, uniformly low values returned are indicative of a problem with the backhaul. Conversely, if any UE reports a good quality channel, then the backhaul must also be good and, for the other UEs, the problem is with the access link. Thus, one simple method is to take the maximum quality reported by the UEs as the quality of the backhaul. When different CQI tables are used by the UEs, the backhaul can be assigned the quality corresponding to the highest efficiency reported. If this falls below a threshold, adjust the backhaul; if not, adjust the access links.

Variations will suggest themselves according to the precise scenario. For example, if the reported link qualities are variable, suggesting movement, then if there is no correlation between variation from different UEs, it could be assumed that the backhaul link is stable and, again, the highest reading in a given period could be taken as representative of the quality of the backhaul link. On the other hand, if the variations have a strong correlated component, then the implication is that the backhaul link is suffering problems due to movement or some other cause.

A similar approach can be taken for the uplink with the CSI signals sent from the UEs. By assigning a quality index similar to the CSI indices returned by the UEs, the gNB can develop a comparative measure of the uplink channels and, using similar heuristics can determine whether to adjust the backhaul or individual access links.

The previous embodiment relies on the presence of many UEs. A third embodiment addresses the case when only one UE is active or when the base station needs to steer both backhaul and access links based on the feedback from a single UE. If a single UE is involved, no comparisons can be made to determine the backhaul channel state separately from the access link. This can also be true if the number of UEs is greater than one but nevertheless insufficient for meaningful comparisons to be made.

In a first embodiment alternative, the base station uses the CSI information to first adjust the access downlink for optimal quality. If the quality is still insufficient (i.e., the CSI information is still reporting low quality), it uses the CSI information to adjust the backhaul link. This assumes that the access link changes frequently and is therefore likely to be the cause of any change in overall link quality. Also, the UE will adjust the access uplink to the best of its ability and anything it cannot resolve may be indicative of a problem in the backhaul. Meanwhile, the backhaul link changes relatively slowly and changes should be made as a last resort. This algorithm can be modified to suit different circumstances. For example, in vehicular scenarios, it can be assumed that the backhaul will change frequently while the access link will be more stable.

In a second embodiment alternative, the base station 10 (slightly) adjusts backhaul and access links independently observing the impact on the CSI reported by the UE. For instance, at time t0 the base station adjusts the (e.g., the beam alignment in the) backhaul link while keeping the access link in its current configuration observing the CSI (improvement/degradation) reported by the UE; at time t1 the base station adjusts the (e.g., the beam alignment in the) access link while keeping the backhaul link in its current configuration observing the CSI (improvement/degradation) reported by the UE; and so on. In this alternative, links should be adjusted independently and the adjustment frequency of one of the links might depend on the nature of the link, e.g., if the access link is more dynamic than the backhaul link because the UE is mobile and the NCR static, then the measurement frequency of the access link will be higher. Alternatively, if the UE is static (with respect to the RIS) and the RIS is mobile (e.g., a vehicle mounted RIS), then the measurement frequency of the backhaul link will be higher.

In a third embodiment alternative, the base station might configure the UE with a higher CSI frequency reporting configuration to ensure that the base station is capable of ensuring the quality of both links.

In a fourth embodiment alternative, the base station might distribute the CSI reporting requirement with regard to the backhaul link over multiple UEs so that the quality of service of a single UE does not suffer too much and the degradation is distributed equally.

In a fifth embodiment alternative, the base station might distribute the CSI reporting requirement with regard to the backhaul link over UEs in a non-connected state.

In a fourth embodiment, the RIS is provided with means to eavesdrop on the CSI sounding signals sent on uplink and downlink in the communication path between gNB and UE(s) and determine an appropriate report to send to the gNB.

In the case of the downlink, the report can be a CSI index as discussed earlier. In one possible implementation, the eavesdropped CSI signals are analysed by the RIS-CM 260 and the result returned to the gNB. The process is identical to the standard CSI procedure except that eavesdropped CSI signals from the communication path are used. The gNB uses this direct measure to adjust the backhaul downlink beam. In a variant approach, the RIS-CM also uses this information to adjust the backhaul uplink beam for the communication path.

In the case of the uplink, the RIS-CM analyses the signals sent from a UE and determines a measure to feed back to the gNB. The gNB compares this with its own measure taken from signals received via the backhaul. Any difference reflects degradations due to the backhaul and the gNB can use this information to update the uplink backhaul beam at the gNB. It can also advise the NCR-MT on adjustments to make to the backhaul uplink beam for the communication path. The signal processing that the RIS-CM has to do corresponds normally to a gNB process. A variant embodiment allows the RIS-CM to process the signals as downlink signals and send an appropriate measure to the gNB.

The previous embodiments rely on the presence of at least one UE in order to provide a measure of the backhaul uplink. This leaves a question on how the system should behave when a repeater is first discovered because there is no way to establish the backhaul beam in readiness for the first UE.

Thus, in a fifth embodiment, the RIS uplink corresponding to a future communication path between the gNB and the UE is arranged to emit a reference signal of some sort that the gNB can use to optimise backhaul uplink beam settings. To avoid interference, the signal should only be used when no other signals are present. The base station can provide the RIS-CM with a schedule for signal generation.

In a first embodiment alternative, optimised for simplicity, the emitted signal is a noise-like signal using a noise source or thermal noise from the input stages of a repeater amplifier. The gNB can use a measure of the received signal strength of the noise signal to optimise beam settings.

In a second embodiment alternative, optimised for compatibility, the gNB can cause the RIS-CM 260 to generate or rebroadcast standard reference signals on the uplink of the backhaul link in specific directions. For instance, the gNB can request the RIS-CM to rebroadcast received signals on the backhaul uplink in four directions at times t0, t1, t2, and t3 while sending at times t0, t1, t2, and t3 SSBs on the control downlink towards the RIS-CM. The RIS will then rebroadcast such SSBs (or any other reference signal such as a CSI-RS). Alternatively, if the RIS has the capability, the gNB can instruct it to generate the SSBs itself and transmit them in the specified directions at the specified times. The gNB can monitor the quality of the received reference signals (re)broadcasted by the RIS, identifying the strongest one and using the extracted information to adjust its backhaul link, e.g., to perform beam alignment or to derive the CSI of the link.

In all alternatives, the RIS might be activated (e.g., transmitting a reference signal) only once the RIS-CM has received a control signal indicating the need of backhaul link configuration.

In principle, this embodiment can also be used when UEs are being served in a manner similar to the methods disclosed in the first embodiment. The main difference is that in this fifth embodiment, the CSI signals are received over the backhaul instead of the control link.

In a further embodiment related to the third embodiment, the base station (or primary station) may in a first step a broadcast channel-state information reference signals (CSI-RS) through different beams associated to the secondary station (or RIS or NCR). In other words, the base station may send in a wide beam broadcast the CSI-RS and may command the secondary station to rebroadcast it through different directional beams in different directions. The UE returns CSI for each of the perceived beams containing the CSI-RS so that the primary station can then have enough information to select the best beam to connect to the UE in the access link, this best beam a is denoted BBA. The primary station may in a second step b send CSI-RS itself through N different beams and command the secondary station to rebroadcast it through BBA. The UE perceives N CSI-RS and collects CSI and sends said CSI to the base station. The base station has enough information to configure the backhaul link, i.e., to select the most suitable beam in the backhaul link. This procedure requires then two steps to configure access and backhaul links where there is a single secondary station between primary station and UE. In a multihop configuration in which there are k secondary stations, then k+1 steps are required, where for each steps N beams/measurements of CSI-RS are involved.

In a related embodiment variant, the base station may broadcast CSI-RS through one base station beam at a time, and for each of them, require the secondary station to rebroadcast it through a different beam at the secondary station. If the primary station has N beams for distributing CSI-RS and the secondary station has M beams for distributing CSI-RS, then a total of M*N measurements of CSI-RS are required and the UE has to report M*N CSI. This procedure also allows the base station (primary station) to determine the best beams for both access link and backhaul link.

In some situations, the secondary station may be a static device, but in other cases it may be a mobile repeater, I.e., a repeater mounted on a vehicle, UAV or a in a satellite. Such a mobile device may move following a known route and/or trajectory. In some cases, the location of a static access device may also be known to some extent. Thus, in a further embodiment, the alignment of the backhaul link may follow a two-step approach wherein the first step consists in a rough alignment based on the rough knowledge of the location of the secondary station, and the second step consists in a fine alignment based on any of previous embodiments. The first step may determine the rough backhaul link alignment between primary station (base station/gNB) and secondary station (mobile repeater) based on the location of the primary station and the location of the secondary station. This can require configuration of the location/trajectory/path of the secondary station in the primary station where in this configuration may be done by the AMF or OAM.

In general, the embodiments described above can be managed as continuous iterative procedures in which in each step the gNB and UE align antenna beams more and more towards the optimum position. In each step, priority may be given to alignment of the backhaul or of the access links, according to the operating scenario.

The above embodiments might also be used independently or in combination with other solutions. For instance, the fifth embodiment might be used as a first solution step for the initial configuration of the backhaul link at the RIS and later operation (e.g., access link configuration) might be based on other techniques.

### INTERFERENCE AVOIDANCE

In another embodiment, interference coordination/mitigation may be achieved by reusing the RIS by multiple base stations (gNBs). In particular, in order to avoid two access devices causing interference by operating one or more RIS elements simultaneously with the same/similar frequency, the RIS may inform one or more of the access devices of the frequency and/or schedule being used/requested/operated by one or more other access devices, e.g. by using the RIS communication module 210 (for example by using the query/control communication protocol or by sending a notification/measurement). The RIS may be equipped with one or more sensors to detect interference. If interference is detected, this may be reported to one or more of the access devices, or the RIS may change its state or stop its operation. The RIS may use measurement information from one or more sensors and/or its built-in UE capabilities to identify the access devices from which the signals originate and/or to calculate the angle of arrival of the signal(s) causing interference and report this information to the one or more access devices. Also RF measurement information may be reported, to the one or more access devices such as channel state information, signal strength, frequency information and other information about the received signals such as timing advance information.

When a gNB uses the RIS, its range may be extended leading to a potential interference in another area. The gNB may inform a second gNB about its wish to use the RIS including the desired area of coverage, frequency and/or timing. This can be done e.g. through the Xn control plane interface between gNBs as defined by 3GPP. The second gNB can confirm/deny this usage. The Xn interface may also be used to synchronize the clocks of the two gNBs and/or to align their schedules to use the RIS.

A UE connected to the second gNB may measure a given interference level caused by the RIS that is currently controlled by a first gNB. The UE can inform the second gNB about the interference level, and the origin. The origin can be indicated if the gNB sends a CSI-RS linked to the RIS with its identifier. The second gNB can then use the Xn control plane interface to inform the first gNB.

Another consideration refers to the fact that in above embodiments a gNB is capable of using an RIS to communicate with a UE at a time. However, existing gNBs are able of MIMO operation by using multiple beams. In some scenarios it is desired to control an RIS capable of handling multiple beams simultaneously. In an embodiment, this can be done when the RIS behaves differently depending on the properties of the incident electromagnetic (EM) wave, e.g., depending on the frequency, polarization, etc. For such an RIS, it is possible for the gNB to control the RIS so that the reflection/refraction/redirection angle depends on the EM properties of the incident wave so that the gNB can communicate with two different UEs simultaneously through the same RIS. The procedure may be as follows: 1) the gNB sets the RIS at a given state at a given period of time, the state referring to refraction/reflection/redirection properties that depend on certain properties of the incident EM wave (e.g., frequency, polarization, etc); 2) the gNB transmits two or more beams towards the RIS, each of the beams featured by specific properties (e.g., frequency, polarization, etc) that are handled differently by the current RIS state so that the beams are split at the RIS. In this procedure, the RIS state is such that the gNB will reach two or more UEs, at different locations, simultaneously, when sending two or more beams towards the RIS since the two or more beams sent from the gNB to the UEs through the RIS will be reflected/refracted/redirected differently by the RIS. Similar behavior is applicable to a smart repeater.

To summarize, a system and method for determining and controlling a reconfigurable relay device (e.g., a reconfigurable intelligent surface, RIS, or a smart repeater) have been described, wherein the reconfigurable relay device is registered and a wireless communication path is established from a network (e.g. access device) via the reconfigurable relay device to a terminal device and wherein optimum quality of both the backhaul and the access link is maintained by forming an estimate of link quality for each link independently. The network registers the reconfigurable relay device and determines parameters needed for its control. The control may be achieved by validated and accepted commands and queries. A relay state of the relay device may be set so that a beam for the wireless communication path is correctly redirected at the terminal device.

While the invention has been illustrated and described in detail in the drawings and foregoing description, such illustration and description are to be considered illustrative or exemplary and not restrictive. The invention is not limited to the disclosed embodiments. It can be applied to various types of UEs or terminal devices, such as mobile phone, vital signs monitoring/telemetry devices, smartwatches, detectors, vehicles (for vehicle-to-vehicle (V2V) communication or more general vehicle-to-everything (V2X) communication), V2X devices, Internet of Things (IoT) hubs, IoT devices, including low-power medical sensors for health monitoring, medical (emergency) diagnosis and treatment devices, for hospital use or first-responder use, virtual reality (VR) headsets, etc.

The BS may be any network access device (such as a base station, Node B (eNB, eNodeB, gNB, gNodeB, ng-eNB, etc.), access point or the like) that provides wireless access to devices in a geographical service area (indoor or outdoor).

The RIS may be created by use of smart devices (e.g., a smart TV or a smart Infrared panel) with hardware components (e.g., a large glass screen or panel) which could be regarded as a good reflector. The RIS may also be embedded into an object such as a billboard, building façade, poster, floor tile, roof, wall, etc. Furthermore, in the above embodiments, the RIS may be replaced by a smart repeater or RF repeater or any relay device with a controllable relay or reflection function.

Furthermore, at least some of the above embodiments may be implemented to provide network equipment for 5G/6G/xG cellular networks or a new product class of (low-cost/mid-cost) reconfigurable intelligent surfaces to improve coverage, reliability and speed of cellular networks.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated. Moreover, it will be understood by those skilled in the art that, in general, terms used herein, and especially in the appended claims, are generally intended as “open” terms, e.g., the term “including” should be interpreted as “including but not limited to,” the term “having” should be interpreted as “having at least,” the term “comprises” should be interpreted as “comprises but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” i.e., “a” and/or “an” should be interpreted to mean “at least one” or “one or more;” the same holds true for the use of definite articles used to introduce claim recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.

The described operations like those indicated in FIGS. 2 and 11 can be implemented as program code means of a computer program and/or as dedicated hardware of the related network device or function, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. A method for operating a network, said network comprising a primary station in communication with a terminal station via a secondary station, said secondary station being configured to relay signals exchanged between the primary station and the terminal station, the secondary station exchanging data with the primary station on a backhaul link and with the terminal station on a dedicated access link,
the method comprising managing the access link according to a measured quality between the primary station and the terminal station or to an indirect estimation of channel quality and, managing the quality of the backhaul link based on an indirect estimation or according to a measured quality.

2. A method for operating a primary station in a network, the primary station being in communication with one or more terminal station via a secondary station, said secondary station being configured to relay signals exchanged between the primary station and the one or more terminal station, the secondary station exchanging data with the primary station on a backhaul link and with the terminal station on a dedicated access link,
the method comprising the primary station managing the access according to a measured quality between the primary station and the terminal station and,
the primary station managing the quality of the backhaul link between the primary station and the secondary station based on an indirect estimation or according to a measured quality.

3. The method of claim 1, wherein a control link is also established between the primary station and the secondary station, and wherein the backhaul link quality is estimated on the basis of the control link quality.

4. The method of claim 3, wherein the control link and the backhaul link are exchanged on overlapping bandwidths or on the same bandwidth.

5. The method of claim 3, wherein the control link and the backhaul link are exchanged on adjacent bandwidths.

6. The method of claim 1, wherein the backhaul link between the primary station and the secondary station uses the same frequency and/or antenna resources as a control link established between the primary station and a secondary station,
and wherein the access links are managed according to channel state information exchanged between the primary station and the terminal stations and the backhaul link is managed according to channel state information exchanged between the primary station and the secondary station for the control link.

7. The method of claim 1, wherein the backhaul link indirect estimation is performed on active links estimation statistics.

8. The method of claim 7, wherein the active links estimation statistics includes at least one out of the following set:
the maximum access link quality value,
the maximum access link quality value compared to a threshold,
the maximum access link quality value compared to an average of access link quality values,
the average of access link quality values,
the average of access link quality values compared to a threshold,
the variance of a sample or all access link quality values,
the variability of access link quality values over time.

9. The method of claim 7, wherein the backhaul link indirect estimation is performed on active links estimation statistics if the number of terminal stations is greater than a predefined threshold.

10. The method of claim 1, wherein the primary station first adjusts an access link with the terminal station, determines how the link quality value evolves after this first adjustment, and decides whether to adjust the backhaul link at least on this determination of the evolution of the link quality value.

11. The method of claim 10, wherein, if it is determined that the link quality value remains substantially unchanged, the primary station adjusts the backhaul link.

12. The method of claim 1, wherein the primary station first adjusts one of the backhaul link with the secondary station or the access link with the terminal station, determines how the link quality value evolves after this first adjustment, and decides whether to adjust the other of the backhaul link or the access link at least on this determination of the evolution of the link quality value.

13. The method of claim 1, wherein the reporting frequency of the link access quality depends on whether the terminal station communicates with the primary station via a secondary station.

14. The method of claim 13, wherein the reporting frequency of the link access quality is higher if the terminal station communicates with the primary station via a secondary station.

15. The method of claim 1, wherein the reporting frequency depends on whether the terminal station communicates with the primary station via a secondary station and on how many terminal stations are communicating with the primary station via the secondary station.

16. A method for operating a secondary station in a network, said network comprising a primary station in communication with one or more terminal station via the secondary station, said secondary station being configured to relay signals exchanged between the primary station and the terminal station, the secondary station exchanging data with the primary station on a backhaul link and with the terminal station on a dedicated access link,
the method comprising the secondary station monitoring probe signals from the primary station for the terminal stations and/or from the terminal stations to the primary station,
generating a backhaul link quality report to be sent to the primary station.

17. The method of claim 16, wherein the backhaul link quality report is transmitted on a control link between the secondary station and the primary station.

18. The method of claim 16, wherein the backhaul link quality report is transmitted on the backhaul link to the primary station.

19. The method of claim 16, wherein the probe signal is one out of the following set: a noise, a thermal noise, a pseudo random sequence, a reference signal, or a pilot signal.

20. A secondary station operating in a network, said network comprising a primary station in communication with a terminal station via the secondary station, said secondary station being configured to relay signals exchanged between the primary station and the one or more terminal stations, the secondary station exchanging data with the primary station on a backhaul link and with the terminal station on a dedicated access link,
the secondary station comprising a controller for monitoring channel state information signals from the primary station for the terminal stations, the controller being arranged to control a transmitter to transmit a backhaul link quality report to be sent to the primary station.

21. A method for operating a secondary station in a network, said network comprising a primary station in communication with a terminal station via a secondary station, said secondary station being configured to relay signals exchanged between the primary station and the terminal station, the secondary station exchanging data with the primary station on a backhaul link and with the terminal station on a dedicated access link,
the method comprising sending a probe signal to the primary station, so that an estimation of the backhaul link quality is done at the primary station.

22. The method of claim 21, wherein the probe signal is a reference signal inserted by the secondary station in the signal sent on the backhaul link.

23. The method of claim 21, wherein the secondary station receives a reference signal from the terminal station on the access link to estimate the quality of the access link and the secondary station rebroadcasts the received reference signal on the backhaul link for the primary station to estimate the backhaul link quality.

24. The method of any of claim 21, wherein the sending of a probe signal is performed during low activity periods.

25. The method of claim 24, wherein low activity periods are time windows during which no signal is expected.

26. The method of claim 24, wherein low activity periods are time windows arranged with the primary station during which no other probe signal is expected.

27. The method of claim 21, wherein the probe signal is one out of the following set: a noise, a thermal noise, a pseudo random sequence, a reference signal, or a pilot signal.

28. A secondary station operating in a network, said network comprising a primary station in communication with a terminal station via the secondary station, the secondary station being configured to relay signals exchanged between the primary station and the terminal station, the secondary station exchanging data with the primary station on a backhaul link and with the terminal station on an access link,
the secondary station comprising a transmitter for sending a probe signal to the primary station, so that an estimation of the backhaul link quality is done at the primary station.

29. A primary station operating in a network, said primary station being in communication with a terminal station via a secondary station, the secondary station being configured to relay signals exchanged between the primary station and the terminal station, the secondary station exchanging data with the primary station on a backhaul link and with the terminal station on an access link,
the primary station being configured to receive a probe signal from the secondary station, and to estimate a backhaul link quality based on measurements on the probe signal,
the primary station being configured to adjust the backhaul link on the basis of the backhaul link quality.

30. The primary station of claim 29, wherein the primary station is also configured to adjust the access link on the basis of at least the backhaul quality.

31. A wireless network comprising a primary station in communication with a terminal station via a secondary station, said secondary station being configured to relay signals between the primary station and the one or more terminal station, the secondary station exchanging data with the primary station on a backhaul link and with the terminal station on an access link,
wherein the network comprises
an access link manager for managing access links between the secondary station and the terminal stations according to a measured quality between the primary station and the terminal station or to an indirect estimation of channel quality and
a backhaul link estimator for estimating the quality of the backhaul link between the primary and secondary stations indirectly, and
a backhaul link manager to adjust the backhaul link based on the indirect backhaul link estimation or according to a measured quality.

32. The network of claim 31 wherein adjustment of each access link independently comprise one or more of the following list:
Adjusting the direction and shape of radio beams between the secondary station and the terminal station,
Selecting a modulation format and coding rate,
Selecting a symbol rate, or
Selecting an operating bandwidth.

33. The network of claim 31 wherein adjustment of the backhaul link comprises adjusting the direction and shape of radio beams between the primary station and the secondary station.

34. The network of claim 31 wherein the backhaul link between the primary station and the secondary station uses the same frequency and antenna resources as a control link established between the primary and secondary stations, with both links being managed according to channel state information exchanged between the primary station and the secondary station for the control link.

35. The network of claim 31, wherein multiple access links are managed by the primary station and the quality of the backhaul link is estimated as a function of the measured quality of said multiple access links.

36. The network of claim 35, wherein the backhaul link quality is estimated as being the same as the maximum of said measured qualities if the multiple access links.

37. The network of claim 35, wherein the primary station determines whether to adjust the backhaul according to one or more of:
Whether the quality estimate falls below a pre-determined threshold;
The impact of recent adjustments on the measured qualities of the access links;
The operating scenario.

38. The network of claim 31, where a single access link is being managed by the primary station wherein the single measured quality is used to adjust both backhaul and access links in separate steps, checking at each step to measure the impact on measured link quality, possibly reversing the adjustment if the measured link quality falls, with the primary station making a decision on which link to adjust according to the measured link quality and other parameters including one or more of:
The impact of recent adjustments on the measured link quality;
The operating scenario.

39. The network of claim 37, wherein the operating scenario includes at least one out of the following: the secondary station is fixed with respect to the primary station, the secondary station is mobile with respect to the primary station, the secondary station is fixed with respect to the terminal stations, the secondary station is mobile with respect to the terminal stations.

40. The network of claim 31, wherein the secondary station comprises means to read channel state information signals sent by the primary station and by the connected terminal stations and send a report to the primary station; at the primary station, using the reported information to derive a measure of the quality of each of the backhaul downlink and the access uplinks.

41. The network of claim 40, wherein the secondary station sends said channel state information signals to the primary station.

42. The network of claim 40, wherein the secondary station derives and returns to the primary station a quality metric for each received link based on the channel state information.

43. The network of claim 40, wherein the secondary station additionally comprises means to exchange channel state information signals with the primary station across the backhaul link; at the primary station, using the received channel state information signals to derive a measure of the quality of the backhaul uplink.

44. A network of claim 1, wherein the uplink and downlink channels operate in the same radio band; at the primary station, estimating the quality of a downlink channel by using a quality measurement of the associated uplink channel and vice versa.
